(19) United States
(12) Patent Application Publication
(10) Pub. No.: US 2026/0155874 A1
(43) Pub. Date: Jun. 4, 2026

(54) METHOD AND APPARATUS FOR PERFORMING HYBRID BEAMFORMING IN WIRELESS COMMUNICATION SYSTEM

(71) Applicants: Samsung Electronics Co., Ltd., Gyeonggi-do (KR); UIF (University Industry Foundation), Yonsei University, Seoul (KR)

(72) Inventors: Soomin KIM, Gyeonggi-do (KR); Siyun YANG, Seoul (KR); Yonghwi KIM, Seoul (KR); Chanbyoung CHAE, Seoul (KR); Hanju YOO, Seoul (KR)

(21) Appl. No.: 19/404,761

(22) Filed: Dec. 1, 2025

(30) Foreign Application Priority Data
Dec. 4, 2024 (KR) 10-2024-0178304

(51) Int. Cl. H04B 7/06; H04B 17/318

(52) U.S. Cl. CPC H04B 7/0626; H04B 7/06952; H04B 17/328

(57) ABSTRACT

The disclosure relates to a 5th generation (5G) or 6th generation (6G) communication system for supporting a higher data rate after a 4th generation (4G) communication system such as long term evolution (LTE. A method performed by a base station may include transmitting first information indicating whether a fixed beam is activated, to a user equipment (UE) via radio resource control (RRC) signaling, transmitting a synchronization signal block (SSB) beam to the UE, based on the first information, receiving second information including information on an intensity of the SSB beam from the UE, transmitting third information indicating whether the fixed beam is activated, to the UE via the RRC signaling, transmitting a channel state information reference signal (CSI-RS) to the UE, based on the third information, receiving a CSI report from the UE, identifying a transmission strategy for the fixed beam, based on the second information and the CSI report, and transmitting data to the UE, based on the identification.

### CROSS-REFERENCE TO RELATED APPLICATION(S)

This application is based on and claims priority under 35 U.S.C. § 119 to Korean Patent Application No. 10-2024-0178304, filed on Dec. 4, 2024, in the Korean Intellectual Property Office, the disclosure of which is incorporated herein by reference in its entirety.

### BACKGROUND

### 1. Field

The disclosure relates generally to a wireless communication system and, more specifically, to a method and an apparatus for performing hybrid beamforming in a wireless communication system.

### 2. Description of Related Art

Based on the development of wireless communication, technologies have been developed mainly for services targeting humans, such as voice calls, multimedia services, and data services. Following the commercialization of 5th generation (5G) communication systems, it is expected that the number of connected devices will exponentially increase and will be connected to communication networks. Such connected things may include vehicles, robots, drones, home appliances, displays, smart sensors connected to various infrastructures, construction machines, and factory equipment. Mobile devices are expected to evolve in various form-factors, such as augmented reality (AR) glasses, virtual reality (VR) headsets, and hologram devices. To provide various services by connecting hundreds of billions of devices and things in the 6th generation (6G) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 microseconds (usec), and thus will be 50 times as fast as 5G communication systems and have the 1/10 radio latency thereof.

To achieve such a high data rate and an ultra-low latency, it has been considered to implement 6G communication systems in a terahertz (THz) band (for example, 95 gigahertz (GHz) to 3THz bands). It is expected that, due to more severe path loss and atmospheric absorption in the THz bands than those in millimeter wave (mm Wave) bands introduced in 5G, technologies capable of securing the signal transmission distance (that is, coverage) will become more vital. It is necessary to develop, as major technologies for securing the coverage, radio frequency (RF) elements, antennas, novel waveforms having a better coverage than orthogonal frequency division multiplexing (OFDM), beamforming and massive multiple-input multiple-output (MIMO), full dimensional MIMO (FD-MIMO), array antennas, and multiantenna transmission technologies such as large-scale antennas. There has been ongoing discussion on new technologies for improving the coverage of terahertz-band signals, such as metamaterial-based lenses and antennas, orbital angular momentum (OAM), and reconfigurable intelligent surface (RIS).

Moreover, to improve the spectral efficiency and the overall network performances, the following technologies have been developed for 6G communication systems: a full-duplex technology for enabling an uplink transmission and a downlink (DL) transmission to simultaneously use the same frequency resource, a network technology for utilizing satellites, high-altitude platform stations (HAPS), and the like in an integrated manner, an improved network structure for supporting mobile base stations (BSs) and enabling network operation optimization and automation, a dynamic spectrum sharing technology via collision avoidance based on a prediction of spectrum usage, an use of artificial intelligence (AI) in wireless communication for improvement of overall network operation by utilizing AI from a designing phase for developing 6G and internalizing end-to-end AI support functions, and a next-generation distributed computing technology for overcoming the limit of UE computing ability through reachable super-high-performance communication and computing resources (such as mobile edge computing (MEC), clouds,) over the network. Through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

A device that adjusts the amplitude and phase of a signal during beamforming is referred to as a beamformer. A scheme of applying such a beamformer in an RF unit may be referred to as analog beamforming, and a scheme of applying a beamformer in a baseband modem may be referred to as digital beamforming.

To combine the advantages of digital beamforming and analog beamforming, a technology called hybrid beamforming, in which digital beamforming is performed based on channel state information (CSI) in the baseband, and then analog beamforming is performed through an RF chain, is also being used.

Digital beamforming and hybrid beamforming technologies may enhance the directivity of a signal in a wireless communication system to improve the efficiency of data transmission. Digital beamforming may combine signals received from each antenna in an antenna array by using a digital signal processing technology to enhance the signal strength in a specific direction. A structure for such digital beamforming has a digital-to-analog converter (DAC), an RF unit, and a power amplifier (PA) connected to each antenna, and thus is able to form a precise beam by independently adjusting the phase and amplitude of each antenna signal. However, since an RF chain is required for each antenna, the hardware cost may increase, and the energy efficiency may be insufficient as a result.

Hybrid beamforming technology may refer to a combination of digital beamforming and analog beamforming technologies and may generate a beam with a wide range by applying an analog phase shifter (PS) to each sub-group of an antenna array, and then generate a final beam pattern by using digital beamforming technology. Hybrid beamforming may maintain a high beamforming performance while reducing the complexity and cost of hardware.

There is a need in the art for a hybrid beamforming technology in which a dynamic metasurface antenna (DMA) that employs a metasurface as an antenna is combined with hybrid beamforming technology, to improve energy efficiency in such technologies.

### SUMMARY

An aspect of the disclosure is to provide a method and an apparatus for performing beamforming in a wireless communication system.

An aspect of the disclosure is to provide a method and a device for performing hybrid beamforming by using a DMA in a wireless communication system.

An aspect of the disclosure is to provide a method for identifying whether a fixed beam interferes and controlling the interference so that a base station operates the tri-hybrid beamforming technology.

An aspect of the disclosure is to provide a signaling method for identifying whether a fixed beam interferes, and a method for determining a usage strategy for the fixed beam, based on the identified interference status of the fixed beam, thereby performing efficient interference control and obtaining high diversity gain.

In accordance with an aspect of the disclosure, a method performed by a base station in a wireless communication system may include transmitting first information indicating whether a fixed beam is activated, to a user equipment (UE) through radio resource control (RRC) signaling, transmitting a synchronization signal block (SSB) beam to the UE, based on the first information, receiving second information including information on an intensity of the SSB beam from the UE, transmitting third information indicating whether the fixed beam is activated, to the UE through the RRC signaling, transmitting a CSI-RS to the UE, based on the third information, receiving a CSI report from the UE, identifying a transmission strategy for the fixed beam, based on the second information and the CSI report, and transmitting data to the UE, based on the identification.

In accordance with an aspect of the disclosure, a base station may include at least one transceiver, and a controller coupled to the at least one transceiver, wherein the controller is configured to transmit first information indicating whether a fixed beam is activated, to a UE through RRC signaling, transmit an SSB beam to the UE, based on the first information, receive second information including information on an intensity of the SSB beam from the UE, transmit third information indicating whether the fixed beam is activated, to the UE through the RRC signaling, transmit a CSI-RS to the UE, based on the third information, receive a CSI report from the UE, identify a transmission strategy for the fixed beam, based on the second information and the CSI report, and transmit data to the UE, based on the identification.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates hybrid beamforming structures according to an embodiment of the disclosure;

FIG. 2 illustrates a structure of a DMA according to an embodiment of the disclosure;

FIG. 3 illustrates a beam structure using a DMA according to an embodiment of the disclosure;

FIG. 4 illustrates an example of operating a beam by using a DMA according to an embodiment of the disclosure;

FIG. 5 illustrates a method of a base station and a UE that controls interference of a fixed beam according to an embodiment of the disclosure;

FIG. 6 illustrates a method of a base station and a UE that controls interference of a fixed beam according to an embodiment of the disclosure;

FIG. 7 illustrates a method of a base station and a UE that controls interference of a fixed beam according to an embodiment of the disclosure;

FIG. 8 illustrates a method of a base station and a UE that controls interference of a fixed beam according to an embodiment of the disclosure;

FIG. 9 illustrates an example of transmitting an SSB beam and a CSI-RS according to whether a fixed beam is activated, according to an embodiment of the disclosure;

FIG. 10 illustrates a method of a base station according to an embodiment of the disclosure;

FIG. 11 illustrates a method of a base station according to an embodiment of the disclosure;

FIG. 12 illustrates a method of a base station according to an embodiment of the disclosure;

FIG. 13 illustrates a method of a base station according to an embodiment of the disclosure;

FIG. 14 illustrates a structure of a base station according to an embodiment of the disclosure; and

FIG. 15 illustrates a structure of a UE according to an embodiment of the disclosure.

With regard to the description of the drawings, the same or like reference signs may be used to designate the same or like elements.

### DETAILED DESCRIPTION

Various aspects of the claimed subject matter are now described with reference to the drawings, wherein like reference numerals are used to refer to like elements throughout. In the following description, for the purpose of explanation, numerous specific details are set forth to provide a full understanding of one or more embodiments. It may be apparent, however, that such embodiment(s) may be implemented without these specific details.

The terms used in the disclosure are used merely to describe particular embodiments, and may not be intended to limit the scope of other embodiments. A singular expression may include a plural expression unless they are definitely different in a context. The terms used herein, including technical and scientific terms, may have the same meaning as those commonly understood by a person skilled in the art to which the disclosure pertains. Such terms as those defined in a generally used dictionary may be interpreted to have the meanings equal to the contextual meanings in the relevant field of art, and are not to be interpreted to have ideal or excessively formal meanings unless clearly defined in the disclosure. In some cases, even the term defined in the disclosure should not be interpreted to exclude embodiments of the disclosure.

In the following description, terms referring to signals (e.g., message, signal, signaling, sequence, and stream), resources (e.g., symbol, slot, subframe, radio frame (RF), subcarrier, resource element (RE), resource block (RB), bandwidth part (BWP), and occasion), operations (e.g., step, method, process, and procedure), data (e.g., information, parameter, variable, value, bit, symbol, and codeword), channels, control information (e.g., DL control information (DCI), medium access control codeword element (MAC CE), and RRC signaling), network entities, device elements, and the like are illustratively used for the sake of convenience. Therefore, the disclosure is not limited by the terms as described below, and other terms referring to subjects having equivalent technical meanings may be used.

Various embodiments of the disclosure are described herein in connection with a wireless terminal and/or a base station. The wireless terminal may refer to a device providing voice and/or data connectivity to a user and may be connected to a computing device such as a laptop computer or desktop computer, or may be a self-contained device such as a personal digital assistant (PDA). The wireless terminal may be a system, a subscriber unit, a subscriber station, mobile station, mobile, remote station, access point, remote terminal, access terminal, user terminal, user agent, user device, UE, a PCS telephone, a cordless telephone, a session initiation protocol (SIP) phone, a wireless local loop (WLL) station, a PDA, a handheld device having wireless connection capability, or other processing device connected to a wireless modem. The base station (e.g., access point) may refer to a device in an access network that communicates over the air-interface, through one or more sectors, with wireless terminals. The base station may act as a router between the wireless terminal and the rest of the access network, which can include an Internet protocol (IP) network, by converting received air-interface frames to IP packets. The base station also coordinates management of attributes for the air interface.

Herein, a hybrid beamforming technology combined with a DMA may be referred to as a tri-hybrid beamforming technology.

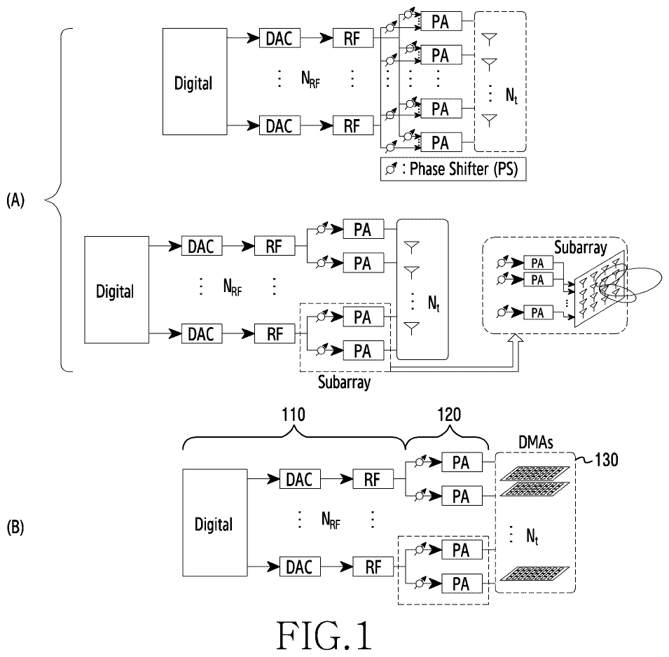

FIG. 1 illustrates hybrid beamforming structures according to an embodiment of the disclosure.

Section (A) of FIG. 1 illustrates hybrid beamforming structures mainly used for 5G MIMO. The hybrid beamforming structures of section (A) OF FIG. 1 apply analog PSs to sub-groups of an antenna array to generate a beam pattern.

As the hybrid beamforming structures of section (A) of FIG. 1, a fully-connected hybrid beamforming structure and a partially-connected hybrid beamforming structure are illustrated. A fully-connected hybrid beamforming structure is a structure in which all RF units are connected to all antenna elements, and a PS is mounted for each connection. The fully-connected hybrid beamforming scheme may require as many PSs as the product of the number of antennas and the number of RF units (the number of antennas * the number of RF units), and thus may use many PSs, thereby increasing hardware complexity. A partially-connected hybrid beamforming structure is a beamforming scheme conceived to reduce the number of PSs used, compared to the fully-connected hybrid beamforming scheme. In the partially-connected hybrid beamforming structure, all RF units are connected to only some antenna elements, and the number of PSs is the same as the number of antennas, and thus, the number of PSs is less than that in the fully-connected hybrid beamforming scheme. In this case, each RF unit is configured to adjust one subarray panel. However, the partially-connected hybrid beamforming scheme may still consume a substantial amount of energy in view of extreme MIMO (X-MIMO) using several thousand antennas.

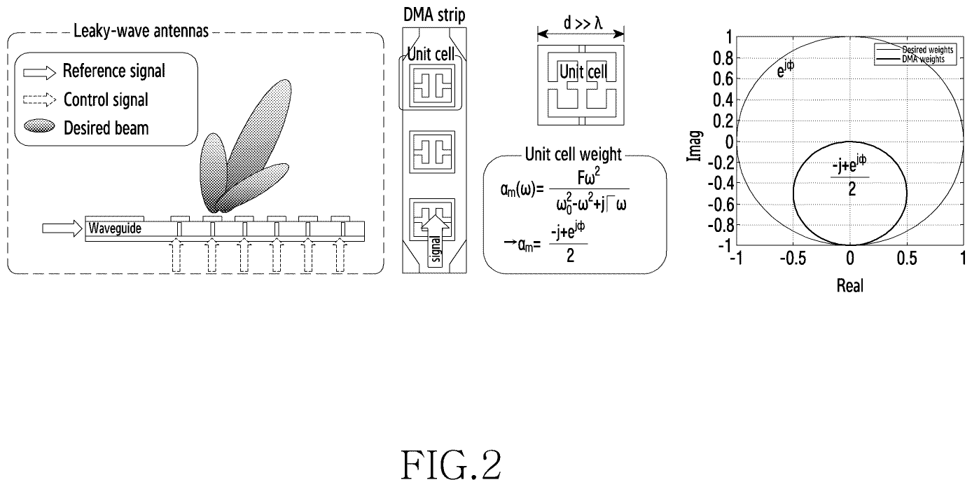

section (B) of FIG. 1 illustrates a hybrid beamforming structure combined with a DMA taught in the disclosure. DMA may refer to one form of an antenna that uses a metasurface as an antenna. Such DMA is a technology of using a metamaterial as an antenna by actively changing the physical characteristics of the metasurface, and the metasurface of a DMA is configured by an array of unit cells having a size of a subwavelength or less. Hereinafter, specific features of DMA will be described later with reference to FIG. 2. In addition, multiple DMAs 130 illustrated in section (B) of FIG. 1 may be the DMA illustrated in FIG. 2.

The hybrid beamforming structure illustrated in section (B) of FIG. 1 may be referred to as a tri-hybrid beamforming structure. Referring to section (B) of FIG. 1, a tri-hybrid beamforming structure may use a plurality of DMAs on an existing antenna layer. In section (B) of FIG. 1, if a resonance change is applied to each unit cell in a DMA, the phase response may be changed, and thus the unit cell may be used instead of the PS used in the hybrid beamforming technology in section (A) of FIG. 1. Although the stand-by power consumed by an activated PS is about 21.6 mW, the stand-by power of a unit cell of a DMA converges to 0 mW, and thus the tri-hybrid beamforming structure proposed in section (B) of FIG. 1 may effectively reduce energy consumption as compared to the hybrid beamforming structures illustrated in section (A) of FIG. 1. Accordingly, the beamforming technology employing the tri-hybrid beamforming structure may enable energy-efficient operation.

For example, under the assumption that the number of antenna elements is 240, the energy efficiency when each beamforming technology is applied may be calculated. Table 1 below shows respective equations for calculating energy consumption when fully-digital beamforming technology used in 4G MIMO, when hybrid-analog beamforming technology used in 5G MIMO (e.g., this technology may refer to a beamforming technology using the partially-connected hybrid beamforming structure illustrated in section (A) of FIG. 1), and when using the tri-hybrid beamforming technology taught in the disclosure.

TABLE 1

| Beamforming technology | Power consumption |
|---|---|
| Fully-digital beamforming architecture | ${P}_{F D} = {P}_{L O} + {N}_{t}^{R F} ( 2 {P}_{D A C} + {P}_{R F} ) + {N}_{t}^{e l e} {P}_{P A}$ |
| Hybrid-analog beamforming architecture | ${P}_{H A} = {P}_{L O} + {N}_{t}^{R F} ( 2 {P}_{D A C} + {P}_{R F} ) + {N}_{P S} ( {P}_{P S} + {P}_{P A} )$ |
| Tri-hybrid beamforming architecture | ${P}_{T H} = {P}_{L O} + {N}_{t}^{R F} ( 2 {P}_{D A C} + {P}_{R F} ) + {N}_{P S} ( {P}_{P S} + {P}_{P A} ) + {N}_{t} {N}_{t}^{u c} {P}_{VAR}$ |

When using the fully-digital beamforming technology, the total power consumption P_{FD} is as given by the equation shown in Table 1. In this case, P_{LO} may indicate the power consumption of a local oscillator,

$${N}_{t}^{R F}$$

may indicate the total number of RF chains used, and

$${N}_{t}^{e l e}$$

may indicate the total number of antenna elements. In addition, PDAC may denote the power consumption of a DAC, P_{RF} may denote the consumption power of an RF chain, and P_{PA} may denote the consumption power of a power amplifier. When using the fully-digital beamforming technology, the equation

$${N}_{t}^{R F} = {N}_{t}^{e l e} = 240$$

may be passion.

When using the hybrid-analog beamforming technology, the total power consumption P_{HA} is as given by the equation shown in Table 1. N_{PS} may indicate the number of PSs, and P_{PS} may indicate the power consumed in a PS. When using the hybrid-analog beamforming technology, the equation

$${N}_{t}^{e l e} = {N}_{P S} = 240$$

may hold, when using the partially-connected hybrid beamforming structure, the equation

$${N}_{t}^{R F} = 15 ∼ 40$$

may hold true. Compared to using the fully-digital beamforming technology, the number of RF chains used when using the hybrid-analog beamforming technology may be reduced, and accordingly, the total power consumption may be reduced.

When using the tri-hybrid beamforming technology proposed herein, the total power consumption PTH is as given by the equation shown in Table 1.

$${N}_{t}^{u c}$$

may refer to the number of unit cells per DMA, and P_{VAR} may refer to the power consumed in a DMA. When using the tri-hybrid beamforming technology, the equation

$${N}_{t}^{e l e} = {N}_{t} {N}_{t}^{uc} = 240$$

may be possible. As described above, the power consumption P_{VAR} of a DMA is almost converged to 0 mW, and thus the value of

$${N}_{t} {N}_{t}^{uc} {P}_{VAR}$$

may be converged to 0. When the tri-hybrid beamforming technology is used, a unit cell of the DMA is used instead of a PS. Therefore, the number N_{PS} of PSs may decrease compared to when the hybrid-analog beamforming technology is used. Accordingly, when using the tri-hybrid beamforming technology, the total power consumption may be reduced as compared to using the fully-digital beamforming technology or the hybrid-analog beamforming technology.

When energy efficiency is defined as the ratio of the total power consumption to the number of antenna elements, the energy efficiency is the highest when the tri-hybrid beamforming technology is used, followed sequentially by the hybrid-analog beamforming technology and the fully-digital beamforming technology.

The tri-hybrid beamforming structure as in section (B) of FIG. 1 may be configured by a total of three types of layers including a digital layer 110 in charge of baseband signal processing, an analog layer 120 for changing the phase of a signal by a PS, and a beam domain layer 130 including multiple DMAs that transform the characteristics of surface waves and radiate the surface waves into a free space. On the digital layer 110, data streams may be allocated to RF chains in the same manner as on the digital layer of the hybrid beamforming shown in section (A) of FIG. 1. PSs may be used also on the analog layer 120 of section (B) of FIG. 1, which may supplement a phase transition capability that may be insufficient when DMAs are used.

FIG. 2 illustrates a structure of a DMA according to an embodiment of the disclosure.

Referring to FIG. 2, a DMA may be configured by an array of unit cells each having a size of a subwavelength or less and arranged on a metasurface. In the DMA, each unit cell may operate as an antenna element while resonating with an electromagnetic wave entering through a waveguide. However, each unit cell has a size smaller than a subwavelength, and thus may have a special physical property. A constraint on phase response occurring in a conventional beamforming technology using a PS corresponds to e^{jφ}, but a unit cell of a DMA may include a weight

$$\frac{- j + {e}^{j φ}}{2}$$

as a constraint on phase response. Using a DMA and using a PS have different constraints for the phase response. Therefore, the hybrid beamforming technology using a PS and the tri-hybrid beamforming technology using a DMA may require different designs and steps.

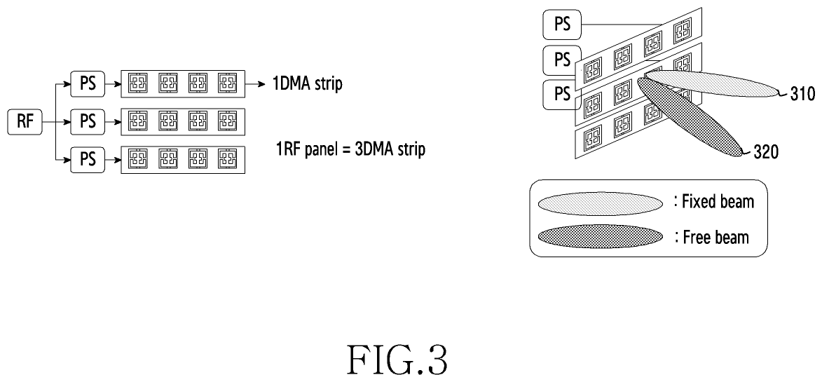

FIG. 3 illustrates a beam structure using a DMA according to an embodiment. Specifically, FIG. 3 illustrates a structure of DMAs being connectable to an RF panel in the tri-hybrid beamforming structure in section (B) OF FIG. 1 described above.

Referring to FIG. 3, three DMA strips may be connected to each RF panel, and one DMA strip may include four DMAs. That is, 12 DMAs in total may be connected to one RF panel to perform a beamforming operation.

Since a unit cell of a DMA has

$$\frac{- j + {e}^{j φ}}{2}$$

as a constraint on phase response, when beams are formed based on a codebook defining beams in various directions, a steerable beam (hereinafter, a free beam) 320 and a non-steerable beam (fixed beam) 310 may be generated separately. The free beam 320 may indicate a beam formed in a desired direction in a shape similar to that of a beam codebook (e.g., discrete Fourier transform (DFT), etc.) formed through a beamforming structure for changing a phase by using a PS in illustrated section (A) OF FIG. 1. The fixed beam 310 may indicate a beam, the direction of which is uncontrollable due to the constraint of a unit cell of a DMA.

Equation (1), Equation (2) and Equation (3) below provide equations for designing a codebook from the viewpoint of an array factor (AF).

$$AE ( φ ) = {\sum }_{i = 1}^{N} {a}_{m , i} {e}^{- j β {x}_{i}} {e}^{- j k {x}_{i} sin φ} \qquad ( 1 )$$

$${a}_{m , i} = \frac{- j + {e}^{j {ψ}_{i}}}{2} , {ψ}_{i} = β {x}_{i} + k {x}_{i} sin {φ}_{0} \qquad ( 2 )$$

$$AE ( φ ) = \frac{1}{2} {\sum }_{i = 1}^{N} ( - j {e}^{- j ( β {x}_{i} + k {x}_{i} sin φ )} + {e}^{j k {x}_{i} ( sin {φ}_{0} - sin φ )} ) \qquad ( 3 )$$

In Equations (1) and (2), a_{m,i} may refer to a weight of a unit cell, e^{-jβ×}^{ᵢ} in Equations (1) and (3) may refer to a parameter for a waveguide, and e^{-jkx}^{ᵢ}^{sinφ} in Equations (1) and (3) may refer to a parameter for an array feature.

In Equation 1 and AE(φ) mapped for codebook design, −je^{-j(β×}^{ᵢ}^{+kx}^{ᵢ}^{sin φ)} to which a parameter a_{m,i} for a unit cell having a phase response constraint is mapped may form a fixed beam, and e^{jkx}^{ᵢ}^{(sin φ}^{₀}^{-sin φ)} may form a free beam intended by a beam codebook.

As described above, it may be identified through Equations (1), (2) and (3) that a fixed beam and a free beam may be formed when beam forming is performed by using a DMA.

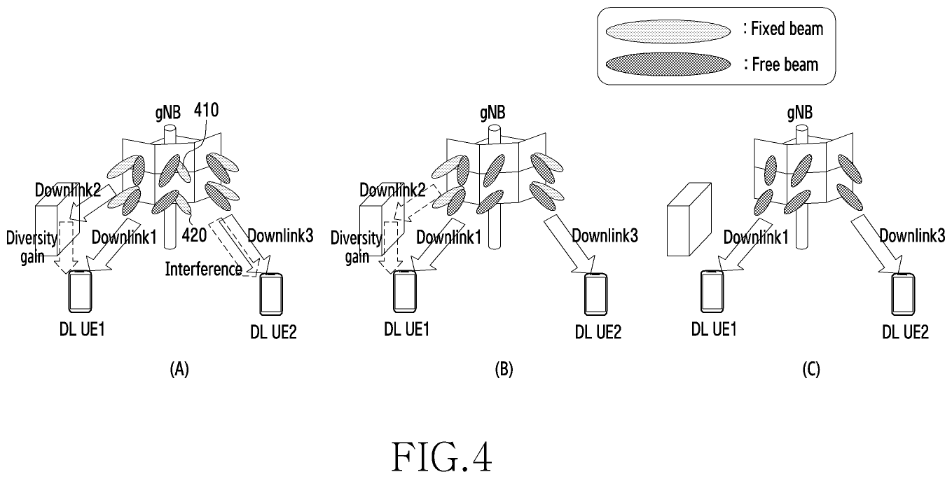

FIG. 4 illustrates an example of operating a beam by using a DMA according to an embodiment. Specifically, FIG. 4 illustrates DL scenarios when a fixed beam described above with reference to FIG. 3 is activated or deactivated when beamforming is performed by using a tri-hybrid beamforming structure.

Referring to section (A) of FIG. 4, a scenario is provided in which fixed beams are activated on all RF panels. DL UE 1 may receive DL 1 using a free beam, and may receive DL 2 using a fixed beam through another path. In this case, because DL 2 using the fixed beam is transmitted to DL UE 1 through the other path, DL 1 and DL 2 may not interfere with each other. From the perspective of DL UE 1, the diversity gain may be increased due to DL 1 and DL 2 received through different respective paths.

DL UE 2 may receive DL 3 using a free beam, and may receive a DL using fixed beams 410 and 420 directed to DL UE 2. In this case, the fixed beams 410 and 420 directed to DL UE 2 are transmitted through the same path as DL 3, unlike DL 2 which is received through a different path, and thus the fixed beams 410 and 420 may cause interference to DL 3. That is, the fixed beams transmitted to DL UE 2 through the same path may act as interference to a free beam. According to the interference caused by the fixed beams, the quality of a signal received by DL UE 2 may be reduced.

Section (B) of FIG. 4 illustrates a scenario in which only fixed beams of some RF panels among all RF panels are activated. The fixed beams 410 and 420 that may act as interference for DL UE 2 in section (A) of FIG. 4 are deactivated in section (B) of FIG. 4. Accordingly, a situation in which the quality of a signal of a free beam received by DL UE 2 is degraded due to interference by a fixed beam may be prevented. In DL UE 1, DL 1 using a free beam and DL 2 using a fixed beam received through a path different from that of DL 1 do not interfere with each other, and thus the diversity gain may be increased.

Section (C) of FIG. 4 illustrates a scenario in which fixed beams are deactivated on all RF panels. Only DL 1 using a free beam may be received by DL UE 1, and DL 2 using a fixed beam may not be received as illustrated in section (A) and section (B) of FIG. 4. The UE's diversity gain may be increased due to DL 2 using the fixed beam received through a different path, but in section (C) of FIG. 4, the diversity gain may be lower than that of DL UE 1 in section (A) and section (B) of FIG. 4 because the fixed beam is deactivated. Since the fixed beams 410 and 420 that may act as interference are deactivated for DL UE 2, a situation in which the quality of a signal (e.g., DL 3) of a free beam received by DL UE 2 is degraded due to interference by a fixed beam may be prevented.

As described above, in a DL scenario, a fixed beam may act as interference and may also be used when increasing diversity gain. That is, since the diversity gain and interference level of a fixed beam received by each UE may differ, a base station needs to determine an optimized control strategy for a fixed beam that may increase the diversity gain while performing interference control.

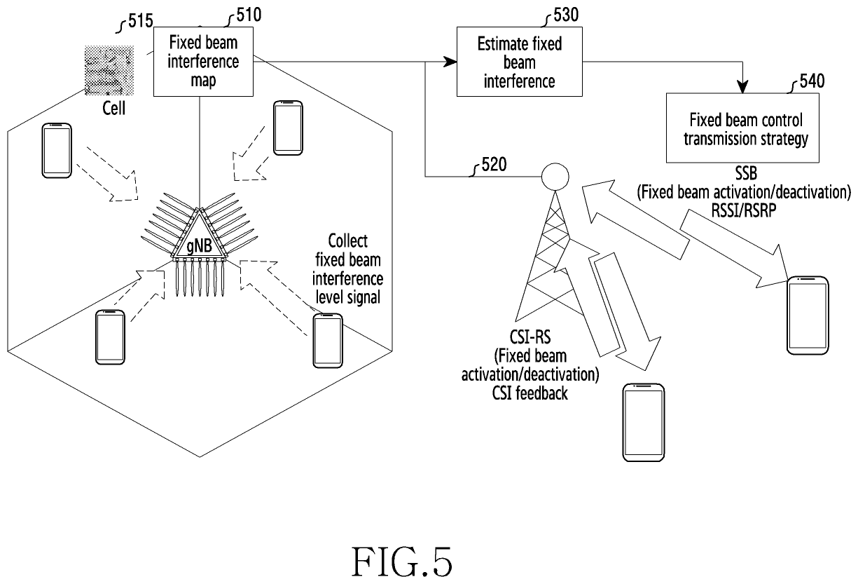

FIG. 5 illustrates a method of a base station and a UE that controls interference of a fixed beam according to an embodiment. Referring to FIG. 5, a method is provided for performing beamforming by using a tri-hybrid beamforming structure in an X-MIMO situation, measuring the level of interference of a fixed beam generated from an RF panel and controlling the interference.

In step 510 of FIG. 5, a base station may generate a fixed beam interference map by considering a characteristic of a DMA and spatial information of a place where the base station is located. The fixed beam interference map may be a map 515 in which the gain of a fixed beam generated for each antenna panel of the base station is mapped to a region supported by a cell of the base station. In one example, each antenna panel forms a 4×3 broad beam, and through the fixed beam interference map for each antenna panel, UEs positioned at specific locations may experience different interference levels. Accordingly, the fixed beam interference map for each antenna panel may represent a different interference level. In addition, when the tri-hybrid beamforming technology of the disclosure is used in X-MIMO, the massive array structural characteristics of ×-MIMO may result in the fixed beam interference of each antenna panel being clearly manifested depending on a location.

The fixed beam interference map may be used like an intensity map representing an interference level, and may be used by the UE or the base station to distinguish the cause of the interference.

The characteristic of the DMA may include, for example, a constraint situation for the phase response of a DMA unit cell. A beam pattern of the fixed beam caused by the unit cell of the DMA may be determined based on the directions of antenna panels (e.g., RF panels) of the base station. The spatial information of the location where the base station is located may be, for example, information indicating the traffic condition, obstacles (buildings or vehicles), and climate in the location in which the base station is located.

The base station may configure a fixed beam interference map indicating the interference level of a fixed beam for each antenna panel of the base station, based on the characteristic of the DMA and the spatial information of the base station.

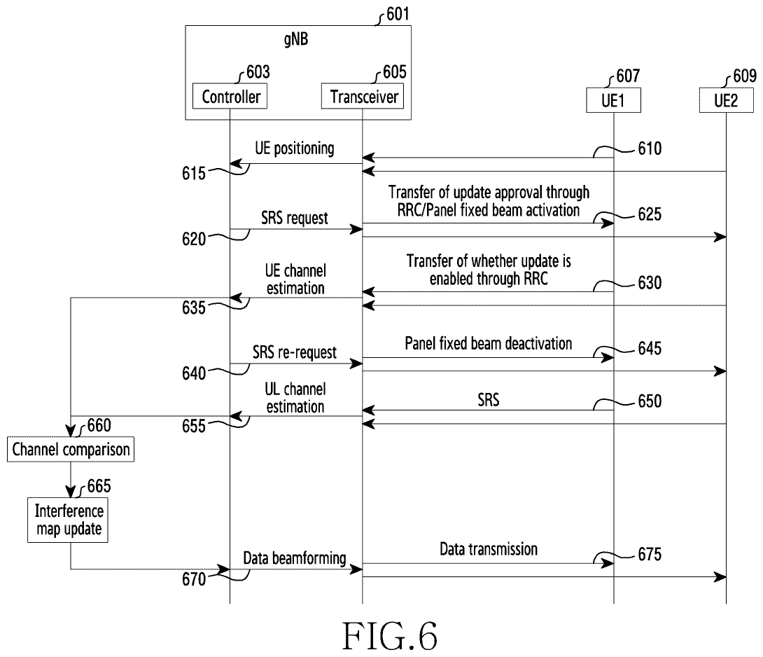

According to an embodiment of the disclosure, the base station may request a sounding reference signal (SRS) from the UE, periodically receive the SRS from the UE, and update the configured fixed beam interference map, as described in detail in FIG. 6.

In step 520, the base station may transmit an SSB or a CSI-RS to the UE, and may receive feedback from the UE. Thereafter, the base station may estimate the interference of a fixed beam by using the feedback received from the UE.

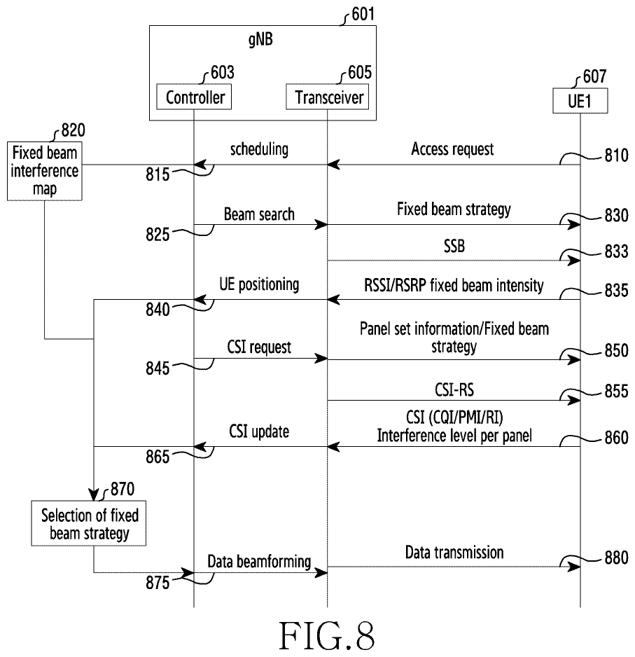

According to an embodiment of the disclosure, the base station may activate or deactivate a fixed beam when transmitting an SSB and a CSI-RS, thereby distinguishing whether the fixed beam is used, and may receive, from the UE, feedback indicating an interference level for each antenna panel. For example, the base station may transmit, to the UE, an SSB beam using a fixed beam having been activated and receive, from the UE, information (e.g., a received signal strength indicator (RSSI), reference signal received power (RSRP), etc.) on the signal strength of the SSB beam and feedback on the interference amount of the fixed beam, and may transmit a CSI-RS using the fixed beam having been deactivated to the UE, and receive a CSI report from the UE. In this case, the CSI report may include information such as a channel quality indicator (CQI), a precoding matrix indicator (PMI), and a rank indicator (RI). A specific operation of estimating the interference of a fixed beam by using SSB beam A and a CSI-RS will be described later in FIG. 8.

In step 530, the base station may estimate the interference situation of the fixed beam by using the piece of information received from the UE and the interference map preconfigured in step 510 together. However, the feedback information obtained by the base station from the UEs in step 520 is not necessarily used together with a preconfigured interference map, and the interference situation of the fixed beam may be estimated only by the feedback information, independently of the interference map.

In step 540, the base station may determine a strategy (or plan, scheme, etc.) for controlling the fixed beam and transmitting data, based on the interference situation of the fixed beam estimated in step 530. The strategy for controlling the fixed beam may be a method of using the fixed beam for each antenna panel of the base station to increase the diversity gain or activating or deactivating the fixed beam to minimize interference.

The base station may estimate the interference situation of the fixed beam in step 530, based on the fixed beam interference map configured in step 510 and the pieces of information acquired from the UE in step 520, and may determine an optimized control strategy for the fixed beam through regression analysis or AI, etc., based on the estimated interference situation.

FIG. 6 illustrates a method of a base station and a UE that controls interference of a fixed beam according to an embodiment.

Referring to FIG. 6, an instance when a base station generates and updates a fixed beam interference map, based on an SRS received from a UE is provided. FIG. 6 illustrates a method of a controller 603 and a transceiver 605 in a base station 601 and multiple UEs (UE 1 607 and UE 2 609). The controller 603 and the transceiver 605 may be included in one base station 601, the controller 603 may control overall operations of the base station, and the transceiver 605 may perform functions for transmitting and receiving signals with a UE through a wireless channel.

In an example, the multiple UEs (UE 1 607 and UE 2 609) may be UEs located in a cell generated by the base station 601.

In step 610, when the UEs (UE 1 607 and UE 2 609) transmit information for UE positioning to the base station 601, in step 615, the transceiver 605 of the base station may transfer the information for positioning received from the UEs to the controller 603. The controller 603 may estimate the locations of the UEs, based on the information.

According to an embodiment of the disclosure, the base station may generate a fixed beam interference map by considering the estimated locations of the UEs, the characteristic of a DMA, and spatial information of a place where the base station is located. The fixed beam interference map may be a map (e.g., the map 515 in FIG. 5) in which the gain of a fixed beam generated for each antenna panel of the base station is mapped to a region supported by the cell of the base station. In an example, the base station may generate a fixed beam interference map by mapping the gain of a fixed beam generated for each antenna panel of the base station to a region supporting the cell of the base station.

In step 620, the controller 603 of the base station may transmit, to the transceiver 605, an SRS request to be transmitted to the UE to update the generated fixed beam interference map.

In step 625, the transceiver 605 may, based on the SRS request received in step 620, transmit information (or a message) for requesting a measurement of the interference level of the fixed beam through RRC signaling to update the fixed beam interference map. The base station may activate the fixed beam of the antenna panel to transmit RRC signaling to the UEs (UE 1 607 and UE 2 609).

In step 630, the UEs (UE 1 607 and UE 2 609) may transmit an SRS to the transceiver 605 of the base station. The SRS transmitted by the UEs (UE 1 607 and UE 2 609) may include information (e.g., RSSI, RSRP, etc.) on the intensity of the beam used in step 625 and information on the interference amount of the activated fixed beam. The UEs (UE 1 607 and UE 2 609) may transmit, through RRC signaling, information on whether the interference map is updatable. For example, the information on whether the interference map is updatable may be transmitted to the base station by the UEs (UE 1 607 and UE 2 609) through RRC signaling before operation 630 is performed, and the information on whether the interference map is updatable may be information indicating that the UE is able to transmit information for updating the interference map to the base station.

In step 635, the transceiver 605 may transfer the information received from the UEs (UE 1 607 and UE 2 609) to the controller 603 to request estimation of a channel toward the UE. The controller 603 may estimate a channel state of the antenna panel of the base station, based on the SRS including the information (e.g., RSSI, RSRP, etc.) on the intensity of the beam used in step 625 and the information on the interference amount of the activated fixed beam, which has been transferred through the transceiver 605.

In step 640 and step 645, the base station may deactivate the fixed beam of each antenna panel and re-request the SRS from the UE. The controller 603 of the base station may request the transceiver 605 to transmit and receive an SRS re-request for the UE to update the interference map, and the transceiver 605 may transfer the SRS re-request to the UEs (UE 1 607 and UE 2 609). At this time, in a state where the fixed beam of each antenna panel of the base station is deactivated, the SRS re-request may be transmitted to the UEs (UE 1 607 and UE 2 609).

In step 650, the UEs (UE 1 607 and UE 2 609) may transmit an SRS to the base station 601, based on the SRS re-request received in step 645. The SRS transmitted by the UEs (UE 1 607 and UE 2 609) may include information (e.g., RSSI, RSRP, etc.) on the intensity of the beam used in step 645. In contrast, the SRS transmitted by the UEs (UE 1 607 and UE 2 609) to the base station 601 in step 650 may not include information on the interference amount of the fixed beam, which is transmitted in step 630.

In step 655, the transceiver 605 may transfer the information received from the UEs (UE 1 607 and UE 2 609) to the controller 603 to request estimation of a channel toward the UE. The controller 603 may estimate a channel state of the antenna panel of the BS, based on the SRS including the information (e.g., RSSI, RSRP, etc.) on the intensity of the beam used in step 645, which has been transferred through the transceiver 605.

According to an embodiment of the disclosure, in step 660, the base station may compare the channel estimated in step 635 and the channel estimated in step 655. The channel estimated in step 635 is a channel considering a beam using the fixed beam activated in step 625, and the channel estimated in step 655 may be a channel considering a beam using the fixed beam deactivated in step 645.

In step 665, the base station may update the pre-generated fixed beam interference map, based on a result of comparing the channels in step 660. The base station may calculate, as a fixed beam gain, a difference between the channel estimated in step 635 and the channel estimated in step 655, and may update the interference map.

In steps 670 and 675, the base station may perform data communication with UE 1 607 and UE 2 609 in consideration of the interference map updated in step 665.

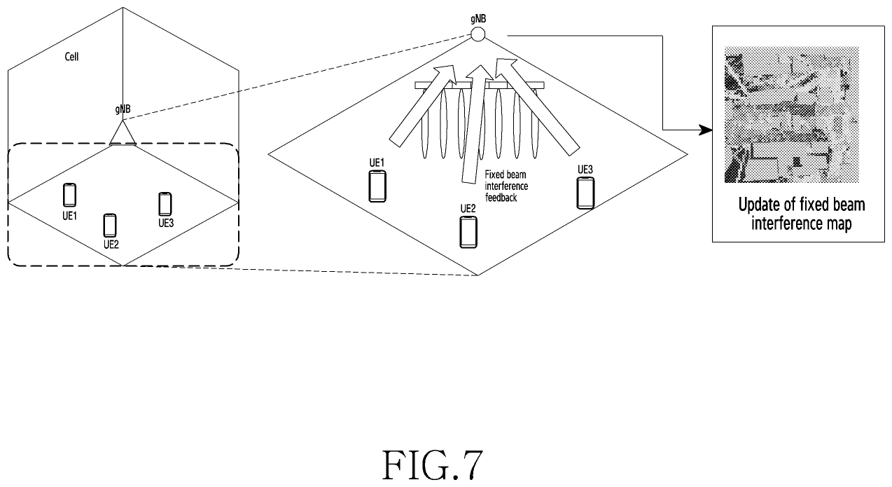

FIG. 7 illustrates a method of a base station and a UE that controls interference of a fixed beam according to an embodiment of the disclosure.

Referring to FIG. 7, an example in which the base station receives feedback information on fixed beam interference from the UEs, and updates a fixed beam interference map, based on the received feedback information, which is illustrated in FIG. 6.

Referring to FIG. 7, a base station may receive information for positioning from UEs (e.g., UE 1, UE 2, and UE 3) to estimate the locations of the UEs. The base station may identify a zone in which the UEs (UE 1, UE 2, and UE 3) are located in a cell configured by the base station.

The base station may request feedback information on fixed beam interference from UE 1, UE 2, and UE 3. Accordingly, the base station may directly receive feedback information on fixed beam interference from the UEs (UE 1, UE 2, and UE 3), or may receive periodic signaling (e.g., SRS) including feedback information on fixed beam interference. In one example, a fixed beam interference level in feedback information on fixed beam interference transmitted by each of the UEs (UE 1, UE 2, and UE 3) to the base station may be different from each other.

Thereafter, the base station may identify the interference level of a fixed beam for each antenna panel of the base station, based on the feedback information on fixed beam interference received from the UEs (UE 1, UE 2, and UE 3). Specifically, the base station may analyze (e.g., perform analysis using regression analysis or artificial intelligence learning) a diversity gain and an interference level (intensity) that the fixed beam for each antenna panel of the base station may have on each of the UEs (UE 1, UE 2, and UE 3).

According to an embodiment of the disclosure, the base station may update a pre-generated fixed beam interference map by reflecting, on the interference map, the analyzed diversity gain and interference level that the fixed beam for each antenna panel may have on each of the UEs (UE 1, UE 2, and UE 3). Even when there is no pre-generated interference map, the base station may newly generate a fixed beam interference map, based on the analyzed diversity gain and interference level that the fixed beam for each antenna panel may have on each of the UEs (UE 1, UE 2, and UE 3).

FIG. 8 illustrates a method of a base station and a UE that controls interference of a fixed beam according to an embodiment.

Referring to FIG. 8, the base station obtains information on interference for each antenna panel of the base station by using an SSB beam and a CSI-RS in step 520 of FIG. 5.

FIG. 8 illustrates a method of a controller 603 and a transceiver 605 in a base station 601 and a UE (UE 1 607). UE 1 607 may be a UE located in a cell generated by the base station 601. Although only one UE (UE 1 607) is illustrated herein, the disclosure may be applied to multiple UEs.

In step 810, the UE 1 607 may transmit an access request to the transceiver 605 of the base station 601. In step 815, the transceiver 605 of the base station may transfer the access request received from UE 1 607 to the controller 603 to transmit a scheduling request.

According to an embodiment of the disclosure, the base station 601 may, in step 820, generate a fixed beam interference map indicating a diversity gain and an interference level (intensity) that a fixed beam for each antenna panel of the base station may have on the UE. For example, the base station may generate a fixed beam interference map by considering a characteristic of a DMA and spatial information of a place where the base station is located.

In step 825, the controller 603 of the base station may, based on the access request received from the UE in step 810, proceed with a beam search to estimate the location of the UE. Even when an access request is not received from the UE, if it is determined that there is a need to update a location having already been estimated via UE positioning, the controller 603 of the base station may also proceed with a beam search.

In step 830, the transceiver 605 may transmit, to UE 1 607 through RRC signaling, information indicating whether a fixed beam that may be generated from the antenna panel of the base station is activated or deactivated. The information indicating whether the fixed beam is activated or deactivated may indicate whether an SSB beam to be transmitted by the base station to the UE is based on the activated fixed beam or on the deactivated fixed beam. The information indicating whether a fixed beam that may be generated from the antenna panel of the base station is activated or deactivated may be referred to as a fixed beam transmission strategy, which may be pre-agreed or configured before the base station transmits an SSB and CSI-RS.

In step 833, the transceiver 605 of the base station may, based on the beam search command (or request) received from the controller 603, transmit SSB beams to UE 1 607 to proceed with a beam search.

The transceiver 605 of the base station may activate the fixed beam of the antenna panel of the base station, based on the fixed beam strategy transmitted in step 830, and transmit an SSB beam. When the base station activates the fixed beam of the antenna panel of the base station and transmits an SSB beam, the base station may deactivate the fixed beam of the antenna panel of the base station and transmits a CSI-RS to the UE. Alternatively, the transceiver 605 of the base station may deactivate the fixed beam of the antenna panel of the base station, based on the fixed beam strategy transmitted in step 830, and transmit an SSB beam. When the base station deactivates the fixed beam of the antenna panel of the base station and transmits an SSB beam, the base station may activate the fixed beam of the antenna panel of the base station and transmits a CSI-RS to the UE. That is, the base station may differently configure whether the fixed beam of the antenna panel is activated when transmitting an SSB and a CSI-RS.

When an SSB beam is transmitted while the fixed beam is activated, the SSB beam may be transmitted while the fixed beams of all the antenna panels of the base station are activated.

In step 835, UE 1 607 may transmit feedback information on the SSB received in step 833 to the transceiver 605 of the base station.

When the SSB transmitted by the transceiver 605 of the base station to UE 1 607 in step 833 is based on the activated fixed beam, the feedback information on the SSB transmitted by UE 1 607 to the transceiver 605 may include information on the intensity of the SSB beam and information on the interference level of the fixed beam for each antenna panel. The information on the intensity of the SSB beam may include information on an RSSI or RSRP of a signal of the SSB beam received by UE 1 607.

When the transceiver 605 of the base station deactivates the fixed beam of the antenna panel and transmits an SSB beam to UE 1 607 in step 833, the feedback information on the SSB transmitted by UE 1 607 to the transceiver 605 may include information (e.g., RSSI, RSRP, etc.) on the intensity of the SSB beam. Compared to when the transmitted SSB beam is based on the activated fixed beam, the feedback information on the SSB may not include information on the interference level of the fixed beam for each antenna panel.

In step 840, the transceiver 605 may request UE positioning for estimating the location of UE 1 607, when transferring, to the controller 603, the feedback information on the SSB received from UE 1 607 in step 835.

The controller 603 may perform UE positioning, based on the feedback information on the SSB, to estimate the location of UE 1 607. Thereafter, the controller 603 may arbitrarily map the estimated location of UE 1 607 and the antenna panel of the base station.

In step 845, the controller 603 of the base station may request the transceiver 605 to transmit a CSI request to the UE.

In step 850, the transceiver 605 may transmit, to UE 1 607 through RRC signaling, information indicating whether a fixed beam that may be generated from the antenna panel of the base station is activated or deactivated. The information indicating whether the fixed beam is activated or deactivated may indicate whether a CSI-RS to be transmitted by the base station to the UE is based on an activated fixed beam or on a deactivated fixed beam. The information indicating whether a fixed beam that may be generated from the antenna panel of the base station is activated or deactivated may be referred to as a fixed beam transmission strategy. The fixed beam transmission strategy may be pre-agreed or configured before the base station transmits an SSB and CSI-RS.

The transceiver 605 may transmit, to UE 1 607 through RRC signaling, information on an antenna panel of the base station, which supports the UE. Specifically, the transceiver 605 may transmit, to UE 1 607, information on antenna panels of the base station supporting UE 1 607 among all the antenna panels.

In step 855, the transceiver 605 of the base station may transmit a CSI-RS to UE 1 607.

When the fixed beam of the antenna panel of the base station is activated and an SSB beam is transmitted in step 833, the transceiver 605 of the base station may deactivate the fixed beam of the antenna panel of the base station and transmit a CSI-RS to the UE. As another example, when the fixed beam of the antenna panel of the base station is deactivated and an SSB beam is transmitted in step 833, the transceiver 605 of the base station may activate the fixed beam of the antenna panel of the base station and transmit a CSI-RS to the UE. That is, the base station may differently configure whether the fixed beam of the antenna panel is activated when transmitting an SSB and a CSI-RS.

When a CSI-RS is transmitted in a state in which the fixed beam is activated, the CSI-RS may be transmitted in a state in which only some antenna panels of the antenna panels of the BS are activated. That is, when a CSI-RS is transmitted, unlike when an SSB beam is transmitted, all antenna panels may not simultaneously transmit the CSI-RS, and only a set of some antenna panels may simultaneously transmit the CSI-RS.

In step 860, UE 1 607 may transmit a CSI report regarding the CSI-RS received in step 855 to the transceiver 605 of the base station.

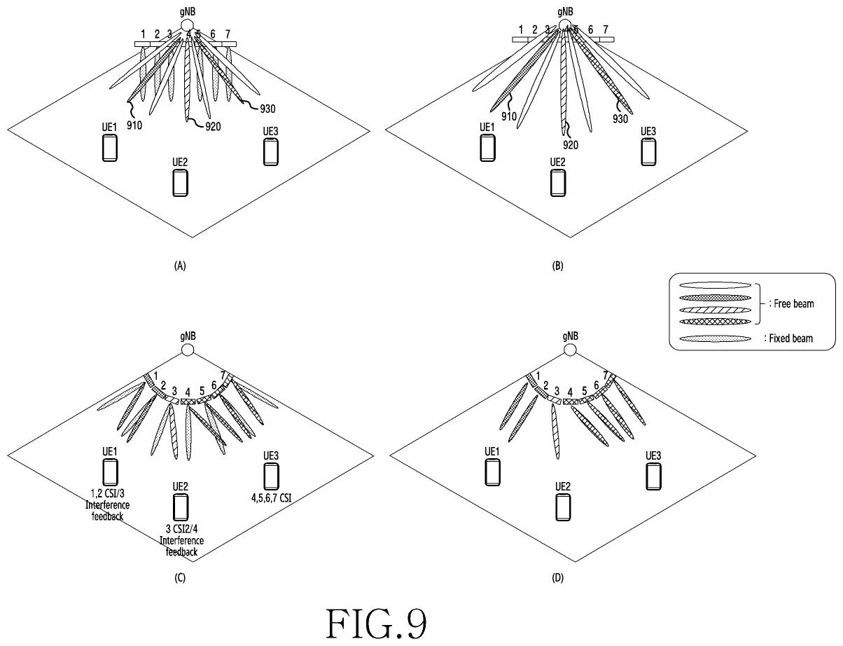

When the CSI-RS transmitted by the transceiver 605 of the base station to UE 1 607 in step 855 is based on the activated fixed beam, the CSI report transmitted by UE 1 607 to the transceiver 605 may include information on a CQI, a PMI, and an RI identified by UE 1 607 based on the CSI-RS, and information on the interference level of the fixed beam for each antenna panel. In an example, UE 1 607 may estimate an antenna panel from which interference has been incurred, based on the information on the panels capable of supporting UE 1 607, which is received in step 850. For example, in section (C) OF FIG. 9, if it is assumed that UE 1 has received information on panel #1 and panel #2 as the information on the panels supporting UE 1 in step 850, and panel #1, panel #2, and panel #3 among the antenna panels are simultaneously activated and CSI-RSs are transmitted to UE 1, UE 1 may feed back, to the base station, a CSI report including CQIs, PMIs, and RIs of channels estimated for panel #1 and panel #2, and information on the interference amount of the fixed beam with regard to panel #3.

UE 1 607 may represent the estimated interference level per antenna panel by indicating same per panel (e.g., by a panel index), and may express the estimated interference level as information on the interference level of the fixed beam of each antenna panel.

When the transceiver 605 of the base station deactivates the fixed beam of the antenna panel and transmits a CSI-RS to UE 1 607 in step 855, the CSI report transmitted by UE 1 607 to the transceiver 605 may include information on a CQI, a PMI, and an RI. Compared to when the transmitted CSI-RS is based on the activated fixed beam, the CSI report based on the CSI-RS transmitted in a state where the fixed beam is deactivated may not include information on the interference level of the fixed beam for each antenna panel.

In step 865, the transceiver 605 of the base station may transfer the CSI report request received from UE 1 607 to the controller 603.

When a CSI-RS is transmitted in a state where the fixed beam is activated, the controller 603 may identify the interference level of a fixed beam of an antenna panel, which may act as interference, other than the antenna panels supporting the UE 1 607, by considering a CSI report and information on the interference level of the fixed beam for each antenna panel.

In step 870, the base station may select (or determine or identify) a usage strategy for the fixed beam. Specifically, the base station may identify an interference effect of the fixed beam for each antenna panel of the base station, by referring to the fixed beam interference map generated in step 820, the feedback information on the SSB beam from the UE received in step 840, and the feedback information on the CSI-RS from the UE received in step 865. The base station may select how to use the fixed beam or an activation/deactivation strategy for the fixed beam of each antenna panel, based on the identified interference effect of the fixed beam for each antenna panel.

According to an embodiment of the disclosure, the base station may estimate whether the cause of the interference incurred for UE 1 607 is a free beam or a fixed beam, by referring to the fixed beam interference map generated in step 820, the feedback information on the SSB beam from the UE received in step 840, and the CSI report information on the CSI-RS from the UE received in step 865. For example, the base station may compare an RSSI value of an SSB beam received in a state in which the fixed beam is deactivated, and a CSI report and information on the interference amount for each antenna panel, which are received in a state in which the fixed beam is activated, so as to estimate the cause of interference. As another example, the base station may estimate the cause of interference by performing regression analysis by using a regression analysis or a neural network (NN) model.

According to an embodiment of the disclosure, the base station may estimate the cause of interference for each antenna panel, and select a different fixed beam usage strategy for each antenna panel, depending on the cause of the interference. For example, when the cause of interference is a fixed beam, the fixed beam of a corresponding antenna panel may be deactivated, and when the cause of interference is estimated to be a free beam, whether a corresponding antenna panel is turned on or off may be determined according to the value of the CQI or RI of a UE using the antenna panel. That is, the base station may estimate the cause of interference for each antenna panel to distinguish whether a fixed beam of the antenna panel acts as a cause of interference or improves a channel state by increasing diversity gain.

In steps 875 and 880, the base station may activate or deactivate the fixed beam for each antenna panel, based on the usage strategy for the fixed beam selected (or identified or determined) in step 870 and perform DL data communication with UE 1 607.

As described above, the base station may identify a fixed beam transmission strategy for activating or deactivating the fixed beam and transmit an SSB beam and a CSI-RS to the UE to receive, from the UE, information on an interference level. Through this operation, the base station may determine an optimized usage strategy for the fixed beam for lowering the interference of the fixed beam and increasing the diversity gain. In particular, when a massive array MIMO communication such as X-MIMO is performed through the operation of the base station proposed in the disclosure, the beamforming having high energy efficiency is possible, as compared to a hybrid beamforming technology using only a PS, and the power for effectively using a fixed beam which may occur during use of a DMA may be determined.

When using a tri-hybrid beamforming technology using a DMA without determining the usage strategies of fixed beams, a strategy of activating or deactivating all fixed beams may be used, which may result in a signal-to-interference plus noise ratio (SINR) value generally lower than that of when the usage strategies of the fixed beams are determined. However, when a usage strategy of a fixed beam is determined and communication is performed based on the determined usage strategy, the SINR performances of UEs may be further improved, so that improved communication performance may be maintained.

FIG. 9 illustrates an example of transmitting an SSB beam and a CSI-RS according to whether a fixed beam is activated, according to an embodiment. The antenna panels illustrated in FIG. 9 are assumed to include antenna panels including panels #1 to #7.

Referring to FIG. 9, section (A) and section (B) illustrate scenarios where a BS transmits an SSB beam. A method of a BS and a UE in section (A) of FIG. 9 and section (B) of FIG. 9 is the same as a method of a BS and a UE in steps 830 to 835 described with reference to FIG. 8.

Section (A) of FIG. 9 illustrates an example of transmitting an SSB beam in a state where a fixed beam of an antenna panel of a BS is activated. When a fixed beam of an antenna panel is activated, fixed beams may be generated from panels #1 to #7.

For example, UE 1 may receive an SSB beam including a free beam 910 having the strongest signal strength among free beams generated from the antenna panels. In this case, the SSB beam received by UE 1 may be affected by interference caused by the fixed beams. Thereafter, UE 1 may transmit feedback information on the received SSB beam to the base station. The feedback information on the SSB may include information (e.g., RSSI or RSRP) on the intensity of the SSB beam and information on the interference level of the fixed beam of each antenna panel. Alternatively, UE 2 may receive an SSB beam including a free beam 920 having the strongest signal strength among the free beams generated from the antenna panels. Thereafter, UE 2 may transmit feedback information on the received SSB beam to the base station. The feedback information on the SSB transmitted by UE 2 to the base station may include information on the intensity of the SSB beam and information on the interference level of the fixed beam of each antenna panel. UE 3 may also receive an SSB beam including a free beam 930 having the strongest signal strength among the free beams generated from the antenna panels, and UE 3 may transmit, to the base station, feedback information on the SSB beam including information on the intensity of the received SSB beam and information on the interference level of the fixed beam of each antenna panel.

Section (B) of FIG. 9 illustrates an example of transmitting an SSB beam in a state where a fixed beam of an antenna panel of a base station is deactivated. In this case, only free beams may be generated from panels #1 to #7 without generation of a fixed beam.

UE 1 may receive an SSB beam including a free beam 910 having the strongest signal strength among the free beams generated from the antenna panels. Thereafter, UE 1 may transmit feedback information on the received SSB beam to the base station. The feedback information on the SSB may include information (e.g., RSSI or RSRP) on the intensity of the SSB beam. In this case, the SSB beam received by UE 1 is not affected by interference incurred by fixed beams, and thus the feedback information on the SSB beam may not include information on the interference level of the fixed beam for each antenna panel. Alternatively, UE 2 and UE 3 may receive SSB beams including respective free beams 920 and 930 having the strongest signal strength, and transmit feedback information on the SSBs including information on the intensities of the SSB beams to the base station.

Sections (C) and (D) of FIG. 9 illustrate scenarios where a base station transmits a CSI-RS. In an example, an operation of a base station and a UE in (C) of FIGS. 9 and (D) of FIG. 9 is the same as a method of a base station and a UE in steps 850 to 860 described with reference to FIG. 8.

Section (C) of FIG. 9 illustrates an example of transmitting a CSI-RS in a state where a fixed beam of an antenna panel of a base station is activated. When a fixed beam of an antenna panel is activated, fixed beams may be generated from panels #1 to #7.

In section (C), panel #1, panel #2, and panel #3 among the antenna panels are simultaneously activated to transmit CSI-RSs to UE 1. If only panel #1 and panel #2 support UE 1, UE 1 may estimate channels of panel #1wn and panel #2 and simultaneously measure an interference level of panel #3. Accordingly, UE 1 may feed back, to the BS, a CSI report including CQIs, PMIs, and RIs of the channels estimated for panel #1 and panel #2, and information on the interference amount of a fixed beam for panel #3. The UE may identify, in advance, information on antenna panels supporting the UE through RRC signaling before the CSI-RSs are transmitted (e.g., step 850 in FIG. 8). In an example, the UE may identify the cause of interference by distinguishing between the antenna panels according to the previously identified information on the antenna panels supporting the UE, and the antenna panels from which CSI-RSs are received.

Panel #2, panel #3, and panel #4 among the antenna panels are simultaneously activated to transmit CSI-RSs to UE 2, and if only panel #3 supports UE 2, UE 2 may estimate a channel of panel #3 and simultaneously measure interference levels of panel #2 and panel #4. Accordingly, UE 1 may feed back, to the base station, a CSI report including a CQI, PMI, and RI of the channels estimated for panel #3, and information on the interference amounts of fixed beams for panel #2 and panel #4.

Panel #4, panel #5, panel #6, and panel #7 among the antenna panels are simultaneously activated to transmit CSI-RSs to UE 3, and UE 3 may estimate channels of panel #4 to panel #7. Accordingly, UE 3 may feed back, to the base station, a CSI report including CQIs, PMIs, and RIs of the channels estimated for panel #4 to panel #7.

Section (D) of FIG. 9 illustrates an example of transmitting a CSI-RS in a state where a fixed beam of an antenna panel of a base station is deactivated. When a fixed beam of an antenna panel is deactivated, only free beams may be generated from panels #1 to #7 without generation of a fixed beam.

When panel #1 and panel #2 among the antenna panels are simultaneously activated to transmit CSI-RSs to UE 1, UE 1 may estimate channels of panel #1 and panel #2 allocated to UE 1. Accordingly, UE 1 may transmit, to the base station, a CSI report including CQIs, PMIs, and RIs of the channels estimated for panel #1 and panel #2.

When panel #3 is activated to transmit a CSI-RS to UE 2, UE 2 may estimate a channel of allocated panel #3, and feed back a CSI report regarding the estimated channel of panel #3. Similarly, UE 3 receives CSI-RSs for panel #4 to panel #7 allocated to UE 3 to estimate channels of panel #4 to panel #7, and feed back a CSI report regarding the estimated channels of panel #4 to panel #7.

In FIG. 9, when the UE transmits feedback to the base station, the base station may identify an interference effect of the fixed beam of each antenna panel of the base station, by referring to the feedback information. The base station may select how to use the fixed beam or an activation or deactivation strategy for the fixed beam of each antenna panel, based on the identified interference effect of the fixed beam for each antenna panel.

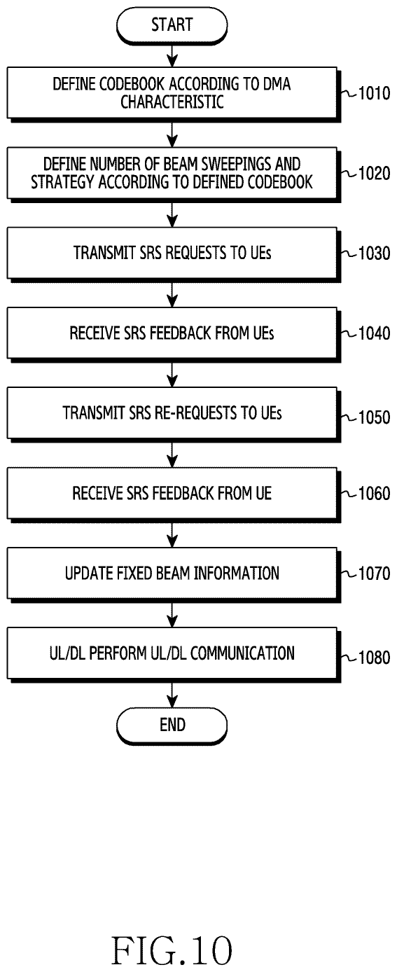

FIG. 10 illustrates a method of a base station according to an embodiment of the disclosure. Specifically, the operation of the base station illustrated in FIG. 10 may include the operation of the base station illustrated in FIG. 6.

Referring to FIG. 10, in step 1010, a base station may define a codebook indicating beams in multiple directions that may be generated on an antenna panel, in consideration of a characteristic of a DMA. A unit cell of the DMA has a constraint

$$\frac{- j + {e}^{j φ}}{2}$$

on phase response, so the defined codebook may be constructed by considering the constraint on phase response.

In step 1020, the base station may define the number of sweepings of a beam which may be generated through the antenna panel, and a strategy for transmitting the beam according to the codebook defined in step 1010. Since the unit cell of the DMA has

$$\frac{- j + {e}^{j φ}}{2}$$

as a constraint on phase response, when beams are formed based on the codebook, a steerable beam (a free beam) and a non-steerable beam (a fixed beam) may be generated separately. The base station may determine the number of beam sweepings and the strategy for transmitting the beam, by considering a free beam and a fixed beam that may be generated in each antenna panel.

The base station may generate a fixed beam interference map by considering the codebook considering the characteristic of the DMA, and spatial information of a place where the base station is located. A beam pattern of the fixed beam caused by the unit cell of the DMA may be determined based on the directions of antenna panels (e.g., RF panels) of the base station. The base station may generate a fixed beam interference map by mapping the gain of a fixed beam generated for each antenna panel of the base station to a region supporting a cell of the base station.

In step 1030, the of the base station may transmit, to a transceiver, SRS requests to be transmitted to UEs to update the generated fixed beam interference map. Even when the interference map of the fixed beam is not generated, the base station may transmit an SRS request to a UE to determine a strategy for controlling the fixed beam of the base station.

According to an embodiment of the disclosure, the base station may transmit, to the UEs through RRC signaling, information (or a message) requesting measurement of an interference level of the fixed beam. The base station may activate the fixed beam of the antenna panel to transmit RRC signaling to the UEs.

In step 1040, the base station may receive SRSs including SRS feedback information from the UEs. The SRS feedback information may include may include information (e.g., RSSI, RSRP, etc.) on the intensity of the beam used for the RRC signaling transmitted by the base station to the UE and information on the interference amount per antenna panel of the activated fixed beam.

According to an embodiment of the disclosure, the base station may estimate a channel state of the antenna panel of the base station, based on the SRS feedback information received from the UE.

In step 1050, the base station may transmit SRS re-requests to the UEs through RRC signaling. In this case, the base station may re-request an SRS for the UE through RRS signaling when the fixed beam of each antenna panel is deactivated. In an example, SRS re-requests may be transmitted to the UEs in a state in which the fixed beam of each antenna panel is deactivated.

In step 1060, the base station may receive SRSs including SRS feedback information from the UEs. In an example, the SRS feedback information may include information (e.g., RSSI or RSRP) on the intensity of the beam used when SRS transmission is requested. In this case, since the transmitted SRS re-requests in step 1050 have been transmitted when the fixed beam is deactivated, the SRS feedback information received by the base station from the UEs in step 1060 may not include information on the interference level of the fixed beam.

According to an embodiment of the disclosure, the base station may estimate a channel state of the antenna panel of the base station, based on the SRS feedback information received from the UE.

In step 1070, the base station may update information on the fixed beam, based on the SRS feedback information received in steps 1040 and 1060. For example, the channel estimated in step 1040 and the channel estimated in step 1060 may be compared. The channel estimated in step 1040 is a channel considering a beam in a state where the fixed beam is activated, and the channel estimated in step 1060 may be a channel considering a beam when the fixed beam is deactivated. The base station may update the pre-generated fixed beam interference map, based on a result of comparing the estimated channels. In an example, the base station may calculate the difference between the estimated channels as a fixed beam gain, and may update the interference map.

Alternatively, if there is no pre-generated interference map, the base station may newly generate an interference map indicating the interference effect of the fixed beam, based on the difference between the estimated channels.

In step 1080, the base station may perform UL or DL data communication with the UEs by considering the updated interference map.

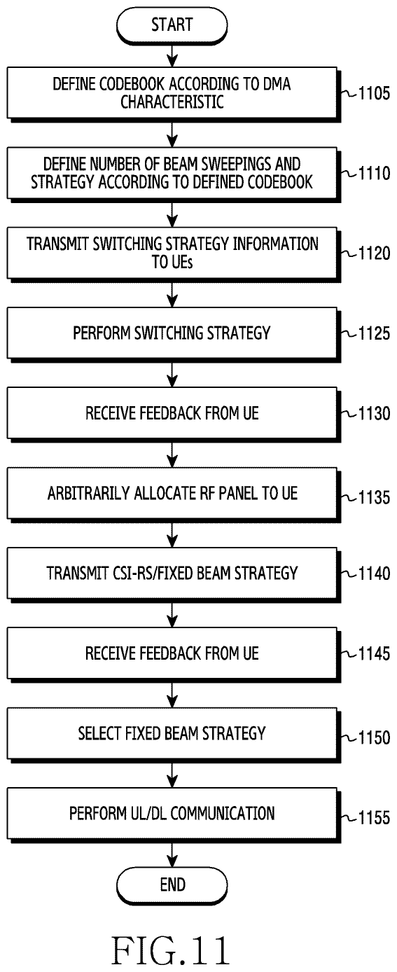

FIG. 11 illustrates a method of a base station according to an embodiment of the disclosure. The operation of the base station illustrated in FIG. 10 may include the operation of the base station illustrated in FIG. 8.

Step 1105 of FIG. 11 is the same as step 1010 of FIG. 10, and step 1110 of FIG. 11 is the same as step 1020 of FIG. 10, so the description thereof will be omitted.

In step 1120, the base station may transmit switching strategy information to the UEs. In an example, the base station may transmit, to the UEs through RRC signaling, information indicating whether a fixed beam that may be generated from the antenna panel of the base station is activated or deactivated. The information indicating whether the fixed beam is activated or deactivated may indicate whether an SSB beam to be transmitted by the base station to the UE is a beam based on the activated fixed beam or a beam based on the deactivated fixed beam. The information indicating whether a fixed beam that may be generated from the antenna panel of the base station is activated or deactivated may be referred to as switching strategy information or a fixed beam transmission strategy. The fixed beam transmission strategy may be pre-agreed or configured before the base station transmits an SSB and CSI-RS.

In step 1125, the base station may perform a switching strategy. For example, the base station may transmit an SSB beam to the UE, based on the switching strategy information described in step 1120.

The base station may activate the fixed beam of the antenna panel of the base station, based on the switching strategy information (or fixed beam transmission strategy) transmitted in step 1120, and transmit an SSB beam. When the base station activates the fixed beam of the antenna panel of the base station and transmits an SSB beam, then the base station may deactivate the fixed beam of the antenna panel of the base station and transmits a CSI-RS to the UE. In another example, the base station may deactivate the fixed beam of the antenna panel of the base station, based on the switching strategy information transmitted in step 1120, and transmit an SSB beam. When the base station deactivates the fixed beam of the antenna panel of the base station and transmits an SSB beam, then the base station may activate the fixed beam of the antenna panel of the base station and transmits a CSI-RS to the UE. That is, the base station may differently configure whether the fixed beam of the antenna panel is activated when transmitting an SSB and a CSI-RS.

When an SSB beam is transmitted in a state in which the fixed beam is activated, the SSB beam may be transmitted in a state in which the fixed beams of all the antenna panels of the BS are activated.

In step 1130, the base station may receive, from the UE, feedback for the SSB beam transmitted in step 1125.

When the SSB beam transmitted by the base station in step 1125 is based on the activated fixed beam, feedback information on the SSB beam received by the base station from the UE may include information on the intensity of the SSB beam and information on the interference level of the fixed beam for each antenna panel. The information on the intensity of the SSB beam may include information on an RSSI or RSRP of a signal of the SSB beam.

When the SSB beam transmitted by the base station in step 1125 is based on the deactivated fixed beam of the antenna panel, the feedback information on the SSB beam received by the base station from the UE may include information (e.g., RSSI or RSRP) on the intensity of the SSB beam. Compared to when the transmitted SSB beam is based on the activated fixed beam, the feedback information on the SSB may not include information on the interference level of the fixed beam for each antenna panel.

In step 1135, the base station may perform UE positioning, based on the feedback information on the SSB received from the UE, thereby estimating the location of the UE. Thereafter, the base station may arbitrarily map the estimated location of UE and the antenna panel of the base station.

In step 1140, the base station may transmit, to the UE through RRC signaling, a CSI-RS together with strategy information of the fixed beam indicating whether the fixed beam that may be generated from the antenna panel of the base station is activated or deactivated. The strategy information of the fixed beam may include information indicating that a CSI-RS is transmitted when the fixed beam is deactivated, when the switching strategy information transmitted in step 1120 indicates transmission of an SSB beam when the fixed beam is activated. The strategy information of the fixed beam may include information indicating that a CSI-RS is transmitted when the fixed beam is activated, when the switching strategy information transmitted in step 1120 indicates transmission of an SSB beam in a state where the fixed beam is deactivated.

The strategy information of the fixed beam may be transmitted to the UE through RRC signaling. The base station may transmit information (e.g., antenna panel set information) on antenna panels supporting the UE through RRC signaling.

In step 1145, the base station may receive, from the UE, feedback for the CSI-RS transmitted in step 1140.

When the transmitted CSI-RS is based on the activated fixed beam, the received feedback for the CSI-RS may include a CSI report including information on a CQI, PMI, and RI identified by UE, and information on the interference level of the fixed beam for each antenna panel. For example, when the UE receives information on supportable panels through RRC signaling, the UE may estimate an antenna panel from which interference has been incurred, based on the antenna panel information.

When a CSI-RS is transmitted in a state where the fixed beam is deactivated, the feedback for the CSI-RS received by the base station from the UE may include a CSI report. Compared to when the transmitted CSI-RS is based on the activated fixed beam, the CSI report based on the CSI-RS transmitted when the fixed beam is deactivated may not include information on the interference level of the fixed beam for each antenna panel.

When a CSI-RS is transmitted in a state where the fixed beam is activated, the base station may identify the interference level of a fixed beam of an antenna panel, which may act as interference, other than the antenna panels supporting the UE, by considering a CSI report and information on the interference level of the fixed beam for each antenna panel.

In step 1150, the base station may select (or determine or identify) a usage strategy for the fixed beam. Specifically, the base station may identify an interference effect of the fixed beam for each antenna panel of the base station, by referring to the feedback information on the SSB beam received from the UE in step 1130, and the feedback information on the CSI-RS from the UE received in step 1145. The base station may select how to use the fixed beam or an activation/deactivation strategy for the fixed beam of each antenna panel, based on the identified interference effect of the fixed beam for each antenna panel.

In step 1155, the base station may activate or deactivate the fixed beam for each antenna panel, based on the selected (or identified or determined) usage strategy for the fixed beam, and perform UL or DL data communication with the UE.

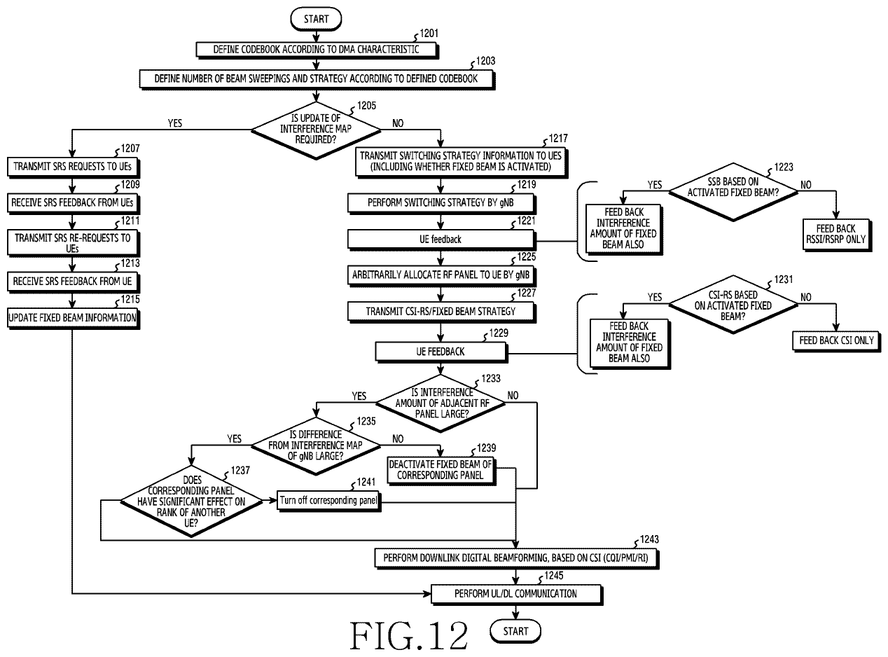

FIG. 12 illustrates a method of a base station according to an embodiment of the disclosure.

Step 1201 of FIG. 12 is the same as step 1010 of FIG. 10 and step 1105 of FIG. 11, and step 1203 of FIG. 12 is the same as step 1020 of FIG. 10 and step 1110 of FIG. 11, so the description thereof will be omitted.

Referring to FIG. 12, in step 1205, the base station may identify whether update of the interference map is required.

When update of the interference map is required, the base station may perform steps 1207 to 1215 by acquiring interference information of the fixed beam through periodic signaling such as SRS, and updating the interference map, based on the interference information of the fixed beam. Steps 1207 to 1215 in FIG. 12 are the same as steps 1030 to 1070 in FIG. 10, and thus the description thereof will be omitted.

When update of the interference map is not required, the base station may perform steps 1217 to 1243. Steps 1217 to 1221 in FIG. 12 are the same as steps 1120 to 1130 in FIG. 11, and thus the description thereof will be omitted.

Step 1223 illustrates when pieces of information included in feedback information on an SSB beam received from the UE by the base station in step 1221 are determined.

When an SSB beam transmitted by the base station to the UE is transmitted when the fixed beam of the antenna panel is activated, the feedback information on the SSB beam may include information on the intensity of the SSB beam and information on the interference level of the fixed beam for each antenna panel. The information on the intensity of the SSB beam may include information on an RSSI or RSRP of a signal of the SSB beam.

When an SSB beam transmitted by the base station to the UE is transmitted when the fixed beam of the antenna panel is deactivated, the feedback information on the SSB beam may include information on the intensity of the SSB beam. Compared to when the transmitted SSB beam is based on the activated fixed beam, the feedback information on the SSB may not include information on the interference level of the fixed beam for each antenna panel.

Thereafter, steps 1225 to 1229 in FIG. 12 are the same as steps 1135 to 1145 in FIG. 11, and thus the description thereof will be omitted.

Steps 1229 to 1231 illustrate when pieces of information included in feedback information on an CSI-RS received from the UE by the base station in step 1231 are determined.

When a CSI-RS transmitted by the base station to the UE is transmitted in a state where the fixed beam of the antenna panel is deactivated, the feedback information on the CSI-RS may include a CSI report including information on a CQI, PMI, and RI identified by UE with regard to a channel of the antenna panel through which the CSI-RS is transmitted, and information on the interference level of the fixed beam for each antenna panel. For example, when the UE receives information on supportable panels through RRC signaling, the UE may estimate an antenna panel from which interference has been incurred, based on the antenna panel information.

When a CSI-RS transmitted by the base station to the UE is transmitted when the fixed beam of the antenna panel is deactivated, the feedback information on the CSI-RS may include a CSI report. Compared to when the transmitted CSI-RS is based on the activated fixed beam, the CSI report based on the CSI-RS transmitted in a state where the fixed beam is deactivated may not include information on the interference level of the fixed beam for each antenna panel.

In steps 1233 to 1241, the base station may perform operations of selecting a strategy for controlling the fixed beam for each antenna panel, based on the feedback information on the SSB beam and the feedback for the CSI-RS, which are received from the UE.

In step 1233, the base station may identify whether an interference amount of an antenna panel, which is adjacent to the UE and may act as interference, other than the antenna panels allocated to the UE is large. In an example, the base station may identify the interference level of a fixed beam of an antenna panel, which may act as interference, other than the antenna panels supporting the UE, by considering a CSI report and information on the interference level of the fixed beam for each antenna panel. When the interference amount of an antenna panel, which is adjacent to the UE and may act as interference, other than the antenna panels allocated to the UE is large, the base station may perform operation 1235.

In step 1235, the base station may identify whether a difference between an interference map of the base station and the interference level of the fixed beam identified by the base station is large. The interference map of the base station may be, for example, the interference map generated in step 1230 (e.g., step 1020 in FIG. 10 or step 1110 in FIG. 11).

When the difference between the interference map of the base station and the interference level of the fixed beam identified by the base station is large, the base station may perform step 1237. When the difference between the interference map of the base station and the interference level of the fixed beam identified by the base station is small or insubstantial, the base station may perform operation 1239.

In step 1239, when the difference between the interference map of the base station and the interference level of the fixed beam identified by the base station is not large, the base station may not perform an additional step and deactivate the fixed beam of the antenna panel, the interference amount of which has been identified as being large.

In step 1237, when the difference between the interference map of the base station and the interference level of the fixed beam identified by the base station is large, the base station may identify whether the antenna panel, the interference amount of which has been identified as being large in step 1233, has a significant effect on the rank of another UE. The base station may identify whether the antenna panel has a significant effect on the rank of another UE, based on information of a CQI and RI in the CSI report received from the UE in the previous operation. When it is determined that the antenna panel has a significant effect on the rank of another UE, the base station may not control the corresponding antenna panel and perform digital beamforming.

In step 1241, when the base station determines that the antenna panel does not have a significant effect on the rank of another UE in step 1237, the base station may deactivate the corresponding antenna panel.

In step 1243, the base station may, based on the operations of operations 1233 to 1241, perform DL digital beamforming for the UE, based on CQI, PMI, and RI, etc. on a channel state included in the CSI report received in step 1229.

In step 1245, the base station may perform data communication with the UE, based on the fixed beam interference map updated in step 1215 or through the digital beamforming in step 1243.

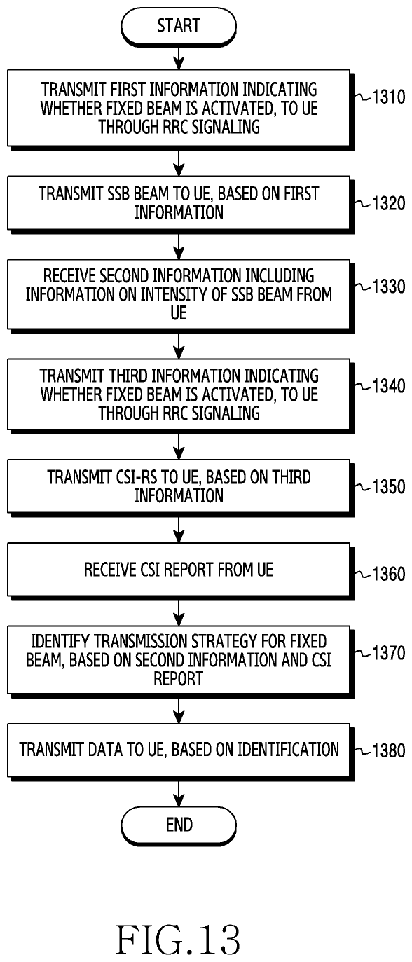

FIG. 13 illustrates a method of a base station according to an embodiment of the disclosure.

Referring to FIG. 13, in step 1310, a base station may transmit first information indicating whether a fixed beam is activated, to a UE through RRC signaling. The fixed beam may indicate a beam, the direction of which is not adjusted on an antenna panel of the base station.

The base station may define a codebook indicating beams in multiple directions that may be generated on the antenna panel, in consideration of a characteristic of a DMA. A unit cell of the DMA has a constraint

$$\frac{- j + {e}^{j φ}}{2}$$

on phase response, so the defined codebook may be constructed by considering the constraint on phase response.

The base station may define the number of sweepings of a beam which may be generated through the antenna panel, and a strategy for transmitting the beam according to the codebook defined by considering the constraint of the unit cell of the DMA. The base station may determine the number of beam sweepings and the strategy for transmitting the beam, by considering a free beam and a fixed beam that may be generated in each antenna panel. The base station may determine a strategy regarding whether to activate or deactivate the fixed beam, when transmitting an SSB beam and a CSI-RS according to the determined number of beam sweepings and the determined strategy for transmitting the beam. The number of beam sweepings and the strategy for transmitting the beam may be included in the first information.

When the fixed beam for an SSB beam is activated, the fixed beam for a CSI-RS may be deactivated. In this case, the first information may indicate activation of the fixed beam for the SSB beam. Alternatively, when the fixed beam for an SSB beam is deactivated, the fixed beam for a CSI-RS may be activated. In this case, the first information may indicate deactivation of the fixed beam for the SSB beam.

In step 1320, the base station may transmit an SSB beam to the UE, based on the first information.

The base station may activate the fixed beam of the antenna panel of the base station, based on the first information including the switching strategy information (or fixed beam transmission strategy) transmitted in step 1310, and transmit an SSB beam. When the base station activates the fixed beam of the antenna panel of the base station and transmits an SSB beam, then the base station may deactivate the fixed beam of the antenna panel of the base station and transmits a CSI-RS to the UE. Alternatively, the base station may deactivate the fixed beam of the antenna panel of the base station, based on the first information, and transmit an SSB beam. When the base station deactivates the fixed beam of the antenna panel of the base station and transmits an SSB beam, then the base station may activate the fixed beam of the antenna panel of the base station and transmits a CSI-RS to the UE. That is, the base station may differently configure whether the fixed beam of the antenna panel is activated when transmitting an SSB and a CSI-RS.

When an SSB beam is transmitted when the fixed beam is activated, the SSB beam may be transmitted when the fixed beams of all the antenna panels of the base station are activated.

In step 1330, the base station may receive second information including information on an intensity of the SSB beam from the UE.

When the SSB beam transmitted by the base station in step 1320 is based on the activated fixed beam, the second information on the SSB beam received by the base station from the UE may include information on the intensity of the SSB beam and information on the interference level of the fixed beam for each antenna panel. The information on the intensity of the SSB beam may include information on an RSSI or RSRP of a signal of the SSB beam.

When the SSB beam transmitted by the base station in step 1320 is based on the deactivated fixed beam of the antenna panel, the feedback information on the SSB beam received by the base station from the UE may include information (e.g., RSSI or RSRP) on the intensity of the SSB beam. Compared to when the transmitted SSB beam is based on the activated fixed beam, the feedback information on the SSB may not include information on the interference level of the fixed beam for each antenna panel.

The base station may estimate the location of the UE, based on the second information. Thereafter, the base station may arbitrarily map the estimated location of UE and multiple antenna panels.

In step 1340, the base station may transmit third information indicating whether the fixed beam is activated, to the UE through RRC signaling. When the fixed beam for an SSB beam is activated, the fixed beam for a CSI-RS may be deactivated. In this case, the third information may indicate deactivation of the fixed beam for the CSI-RS. When the fixed beam for an SSB beam is deactivated, the fixed beam for a CSI-RS may be activated. In this case, the third information may indicate activation of the fixed beam for the CSI-RS.

The third information may further include information in which the location of the UE estimated by the base station and multiple antenna panels are mapped.

In step 1350, the base station may transmit a CSI-RS to the UE, based on the third information.

In step 1360, the base station may receive a CSI-RS report from the UE.

When the transmitted CSI-RS is based on the activated fixed beam, the CSI report may include, as the received feedback for the CSI-RS, information on a CQI, PMI, and RI identified by UE, and information on the interference level of the fixed beam for each antenna panel. When the UE receives information on supportable panels through RRC signaling, the UE may estimate an antenna panel from which interference has been incurred, based on the antenna panel information.

When a CSI-RS is transmitted in a state where the fixed beam is deactivated, Compared to when the transmitted CSI-RS is based on the activated fixed beam, the CSI report based on the CSI-RS transmitted when the fixed beam is deactivated may not include information on the interference level of the fixed beam for each antenna panel.

In step 1370, the base station may identify a transmission strategy for the fixed beam, based on the second information and the CSI report.

When a CSI-RS is transmitted when the fixed beam is activated, the base station may identify the interference level of a fixed beam of an antenna panel, which may act as interference, other than the antenna panels supporting the UE, by considering a CSI report and information on the interference level of the fixed beam for each antenna panel.

In step 1380, the base station may transmit data to the UE, based on the identified transmission strategy of the fixed beam.

The base station may select (or determine or identify) a usage strategy for the fixed beam. Specifically, the base station may identify an interference effect of the fixed beam for each antenna panel of the base station, by referring to the feedback information on the SSB beam received from the UE in step 1320, and the CSI report received in step 1360. The base station may select how to use the fixed beam or an activation/deactivation strategy for the fixed beam of each antenna panel, based on the identified interference effect of the fixed beam for each antenna panel.

The base station may configure a fixed beam interference map indicating the interference level of a fixed beam for each RF antenna panel of the base station. The fixed beam interference map may be configured based on information on a DMA and spatial information of the base station. When the base station identifies a transmission strategy in step 1370, the fixed beam interference map configured by the base station may be used.

The base station may activate the fixed beam of an RF antenna panel and transmit a first SRS request to the UE through RRC signaling. The base station may then receive a first SRS from the UE. The first SRS may be used to estimate a first UL channel for the antenna panel.

The base station may deactivate the fixed beam of the RF antenna panel and transmit a second SRS request to the UE through RRC signaling. The base station may then receive a second SRS from the UE. The second SRS may be used to estimate a second UL channel for the antenna panel.

The base station may update the fixed beam interference map, based on the received first SRS and the second SRS. The fixed beam interference map may be updated based on a difference in the estimated value between the first UL channel estimated based on the first SRS, and the second UL channel estimated based on the second SRS.

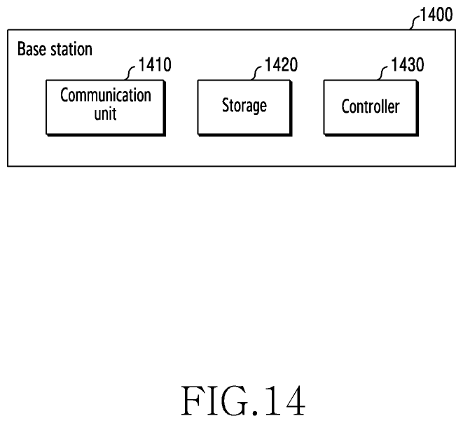

FIG. 14 illustrates a structure of a base station 1400 according to various embodiments of the disclosure.

Referring to FIG. 14, the base station 1400 includes a communication unit 1410, a storage 1420, and a controller 1430.

The communication unit 1410 performs functions for transmitting/receiving signals through a radio channel. For example, the communication unit 1410 performs functions of conversion between baseband signals and bitstrings according to the physical layer specifications of the system. During data transmission, the communication unit 1410 encodes and modulates a transmitted bitstring to generate complex symbols. During data reception, the communication unit 1410 demodulates and decodes a baseband signal to restore a received bitstring. The wireless communication unit 1410 up-converts a baseband signal to an RF band signal, transmits the up-converted RF band signal via an antenna, and then down-converts the RF band signal received via the antenna to a baseband signal.

To this end, the wireless communication unit 1410 may include a transmission filter, a reception filter, an amplifier, a mixer, an oscillator, a DAC, an analog to digital converter (ADC), and the like. The communication unit 1410 may include multiple transmission/reception paths. Furthermore, the wireless communication unit 1410 may include at least one antenna array including multiple antenna elements. In terms of hardware, the wireless communication unit 1410 may include a digital unit and an analog unit, and the analog unit may include multiple sub-units according to operation power, frequencies, etc.

The communication unit 1410 may transmit/receive signals. To this end, the communication unit 1410 may include at least one transceiver. For example, the communication unit 1410 may transmit a synchronization signal, a reference signal, system information, a message, control information, data, or the like. Furthermore, the communication unit 1410 may perform beamforming.

The communication unit 1410 transmits and receives signals as described above. Accordingly, all or part of the communication unit 1410 may be referred to as a transmitter, a receiver, or a transceiver. In addition, as used in the following description, the meaning of transmission and reception performed through a radio channel includes the meaning that the above-described processing is performed by the communication unit 1410.

The storage 1420 may store basic programs, application programs, and data, such as configuration information, for operation of the main base station. The storage 1420 may include a memory. The storage 1420 may include a volatile memory, a nonvolatile memory, or a combination of a volatile memory and a nonvolatile memory. The storage 1440 provides the stored data at the request of the controller 1430.

The controller 1430 controls the overall operation of the base station 1400. For example, the controller 1430 transmits/receives signals through the communication unit 1410.

The controller 1430 records data in the storage 1420 and reads the data from the storage 1420 and may perform functions of protocol stacks required by communication specifications. To this end, the controller 1430 may include at least one processor.

The structure of the base station 1400 illustrated in FIG. 14 is a merely an example of the base station, and examples of the base station for performing various embodiment of the disclosure are not limited to the structure illustrated in FIG. 14. That is, some components may be added, omitted, or changed according to an embodiment.

In FIG. 14, the base station 1400 has been described as a single entity, but the disclosure is not limited thereto. In addition to the integrated deployment, the base station 1400 according to various embodiments of the disclosure may be implemented to construct an access network having a distributed deployment. The base station may be divided into a central unit (CU) and a digital unit (DU), the CU may be implemented to perform upper layer functions (e.g., packet data convergence protocol (PDCP) and RRC), and the DU may be implemented to perform lower layer functions (e.g., MAC and physical (PHY)). The DU of the base station may form beam coverage on a radio channel.

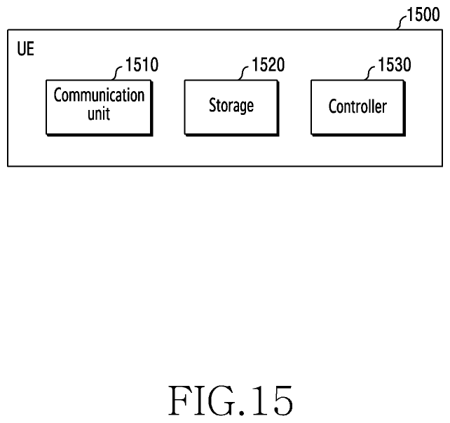

FIG. 15 illustrates a structure of a UE 1500 according to various embodiments of the disclosure.

Referring to FIG. 15, such terms as “ . . . unit” and “ . . . er” refer to a unit configured to process at least one function or operation, and may be implemented as hardware, software, or a combination of hardware and software.

The UE 1500 includes a communication unit 1510, a storage 1520, and a controller 1530.

The communication unit 1510 performs functions for transmitting/receiving signals through a radio channel. For example, the communication unit 1510 performs functions of conversion between baseband signals and bitstrings according to the physical layer specifications of the system. During data transmission, the communication unit 1510 encodes and modulates a transmitted bitstring to generate complex symbols. During data reception, the communication unit 1510 demodulates and decodes a baseband signal to restore a received bitstring. The communication unit 1510 up-converts a baseband signal to an RF band signal, transmits the same through an antenna, and down-converts an RF band signal received through the antenna to a baseband signal. The communication unit 1510 may include a transmission filter, a reception filter, an amplifier, a mixer, an oscillator, a DAC, and an ADC.

The communication unit 1510 may include multiple transmission/reception paths and an antenna unit. The communication unit 1510 may include at least one antenna array configured by multiple antenna elements. In terms of hardware, the communication unit 1510 may include a digital circuit and an analog circuit (e.g., RF integrated circuit (RFIC)). The digital circuit and the analog circuit may be implemented as a single package. The communication unit 1510 may include multiple RF chains. The communication unit 1510 may perform beamforming. To assign directivity based on configurations of the controller 1530 to a signal to be transmitted/received, the communication unit 1510 may apply a beamforming weight to the signal. The communication unit 1510 may include an RF block (or RF unit). The RF block may include first RF circuitry related to antennas and second RF circuitry related to baseband processing. The first RF circuitry may be referred to as an RF-antenna (RF-A). The second RF circuitry may be referred to as an RF-baseband (RF-B).

The communication unit 1510 may transmit/receive signals. To this end, the communication unit 1510 may include at least one transceiver. The communication unit 1510 may receive DL signals. The DL signal may include a synchronization signal (SS), a reference signal (RS) (e.g., demodulation (DM)-RS or phase tracking reference signal (PTRS)), system information (e.g., master information block (MIB), system information block (SIB), remaining system information (RMSI), or other system information (OSI)), a configuration message, control information, DL data, or the like. The communication unit 1510 may transmit UL signals. The UL signal may include a random access-related signal (e.g., random access preamble (RAP) (or message 1 (Msg1), message 3 (Msg3)), a reference signal (e.g., an SRS, a DMRS, or a PTRS), a power headroom report (PHR), or the like.

The communication unit 1510 may include different communication modules to process signals in different frequency bands. Furthermore, the communication unit 1510 may multiple communication modules to support multiple different radio access technologies. For example, different radio access technologies may include Bluetooth® low energy (BLE), wireless fidelity (Wi-Fi), Wi-Fi gigabyte (WiGig), cellular networks (e.g., long-term evolution (LTE)), NR, and the like. In addition, different frequency bands may include super high frequency (SHF) (e.g., 2.5 GHz and 5 GHz) bands and millimeter (mm) wave (e.g., 38 GHz, 60 GHz, etc.) bands. The communication unit 1510 may use a radio-access technology of the same scheme on different frequency bands (e.g., an unlicensed band for licensed assisted access (LAA) and a citizen broadband radio service (CBRS) (e.g., 3.5 GHz)).

The communication unit 1510 transmits and receives signals as described above. Accordingly, all or part of the communication unit 1510 may be referred to as a transmitter, a receiver, or a transceiver. In addition, as used in the following description, the meaning of transmission and reception performed through a radio channel includes the meaning that the above-described processing is performed by the communication unit 1510.

The storage 1520 may store basic programs, application programs, and data, such as configuration information, for the operation of the UE 1500. The storage 1520 may include a volatile memory, a nonvolatile memory, or a combination of a volatile memory and a nonvolatile memory. The storage 1542 provides the stored data at the request of the controller 1553.

The controller 1530 controls the overall operation of the UE 1500. For example, the controller 1530 transmits/receives signals through the communication unit 1510. The controller 1530 records data in the storage 1520 and reads the data from the storage 1520. The controller 1530 may perform functions of protocol stacks required by communication specifications. To this end, the controller 1530 may include at least one processor. The controller 1530 may include at least one processor or micro-processor, or may be a part of a processor. A part of the communication unit 1510 and the controller 1530 may be referred to as a CP. The controller 1530 may include various modules for performing communication. The controller 1530 may control the UE so as to perform various operations according to various embodiments.

As described above, a method performed by a base station in a wireless communication system may include transmitting first information indicating whether a fixed beam is activated, to a UE through RRC signaling, transmitting an SSB beam to the UE, based on the first information, receiving second information including information on an intensity of the SSB beam from the UE, transmitting third information indicating whether the fixed beam is activated, to the UE through the RRC signaling, transmitting a CSI-RS to the UE, based on the third information, receiving a CSI report from the UE, identifying a transmission strategy for the fixed beam, based on the second information and the CSI report, and transmitting data to the UE, based on the identification.

The SSB beam and the CSI-RS may be transmitted through a DMA, and the first information or the third information may indicate whether a fixed beam based on information on the DMA is activated.

The fixed beam may indicate a beam, the direction of which is not adjusted on an antenna panel of the base station.

The first information may indicate activation of the fixed beam for the SSB beam, the third information may indicate deactivation of the fixed beam for the CSI-RS, the second information may further include information on an interference amount of the fixed beam for the SSB beam based on the activated fixed beam, and the information on the intensity of the SSB beam may indicate RSSI and RSRP of the SSB beam.

The first information may indicate deactivation of the fixed beam for the SSB beam, the third information may indicate activation of the fixed beam for the CSI-RS, and the CSI report may further include information on an interference amount of the fixed beam for the CSI-RS based on the activated fixed beam.

The method may include estimating a location of the UE, based on the second information, and mapping the estimated location of the UE and multiple antenna panels, and the third information may include information in which the location of the UE and the multiple antenna panels are mapped.

The method may include configuring a fixed beam interference map indicating an interference level of a fixed beam for each antenna panel of the base station, activating the fixed beam to transmit a first SRS request to the UE through RRC signaling, receiving a first SRS from the UE, deactivating the fixed beam to transmit a second SRS request to the UE through RRC signaling, receiving a second SRS from the UE, and updating the fixed beam interference map, based on the first SRS and the second SRS.

The first SRS may be used to estimate a first UL channel, the second SRS may be used to estimate a second UL channel, and the fixed beam interference map may be updated based on a difference between an estimated value of the first UL channel and an estimated value of the second UL channel.

The fixed beam interference map may be configured based on information on a DMA and spatial information of the BS.

The fixed beam interference map may be used to identify the transmission strategy for the fixed beam.

As described above, a base station may include at least one transceiver, and a controller coupled to the at least one transceiver, wherein the controller is configured to transmit first information indicating whether a fixed beam is activated, to a UE through RRC signaling, transmit an SSB beam to the UE, based on the first information, receive second information including information on an intensity of the SSB beam from the UE, transmit third information indicating whether the fixed beam is activated, to the UE through the RRC signaling, transmit a CSI-RS to the UE, based on the third information, receive a CSI report from the UE, identify a transmission strategy for the fixed beam, based on the second information and the CSI report, and transmit data to the UE, based on the identification.

The SSB beam and the CSI-RS may be transmitted through a DMA, and the first information or the third information may indicate whether a fixed beam based on information on the DMA is activated.

The fixed beam may indicate a beam, the direction of which is not adjusted on an antenna panel of the BS.

The first information may indicate activation of the fixed beam for the SSB beam, the third information may indicate deactivation of the fixed beam for the CSI-RS, the second information may further include information on an interference amount of the fixed beam for the SSB beam based on the activated fixed beam, and the information on the intensity of the SSB beam may indicate an RSSI and RSRP of the SSB beam.

The first information may indicate deactivation of the fixed beam for the SSB beam, the third information may indicate activation of the fixed beam for the CSI-RS, and the CSI report may further include information on an interference amount of the fixed beam for the CSI-RS based on the activated fixed beam.

The controller may be further configured to estimate a location of the UE, based on the second information, and map the estimated location of the UE and multiple antenna panels, and the third information may include information in which the location of the UE and the multiple antenna panels are mapped.

The controller may be configured to configure a fixed beam interference map indicating an interference level of a fixed beam for each antenna panel of the base station, activate the fixed beam to transmit a first SRS request to the UE through RRC signaling, receive a first SRS from the UE, deactivate the fixed beam to transmit a second SRS request to the UE through RRC signaling, receive a second SRS from the UE, and update the fixed beam interference map, based on the first SRS and the second SRS.

The first SRS may be used to estimate a first UL channel, the second SRS may be used to estimate a second UL channel, and the fixed beam interference map may be updated based on a difference between an estimated value of the first UL channel and an estimated value of the second UL channel.

The fixed beam interference map may be configured based on information on a DMA and spatial information of the base station.

The fixed beam interference map may be used to identify the transmission strategy for the fixed beam.

While the disclosure has been shown and described with reference to various embodiments thereof, it will be understood by those skilled in the art that various changes in form and details may be made therein without departing from the spirit and scope of the of the disclosure as defined by the appended claims and their equivalents.

What is claimed is:

1. A method performed by a base station in a wireless communication system, the method comprising:
transmitting, to a user equipment (UE), via radio resource control (RRC) signaling, first information indicating whether a fixed beam is activated;
transmitting, to the UE, a synchronization signal block (SSB) beam, based on the first information;
receiving, from the UE, second information including information on an intensity of the SSB beam;
transmitting, to the UE, via the RRC signaling, third information indicating whether the fixed beam is activated;
transmitting, to the UE, a channel state information reference signal (CSI-RS), based on the third information;
receiving a CSI report from the UE;
identifying a transmission strategy for the fixed beam, based on the second information and the CSI report; and
transmitting, to the UE, data, based on the identification.

2. The method of claim 1,
wherein the SSB beam and the CSI-RS are transmitted via a dynamic metasurface antenna (DMA), and
wherein the first information or the third information indicates whether a fixed beam based on information on the DMA is activated.

3. The method of claim 1,
wherein the fixed beam indicates a beam having an uncontrollable direction on an antenna panel of the base station.

4. The method of claim 1,
wherein the first information indicates activation of the fixed beam for the SSB beam,
wherein the third information indicates deactivation of the fixed beam for the CSI-RS,
wherein the second information further comprises information on an interference amount of the fixed beam with respect to the SSB beam based on the activated fixed beam, and
wherein the information on the intensity of the SSB beam indicates a received signal strength indicator (RSSI) and reference signal received power (RSRP) of the SSB beam.

5. The method of claim 1,
wherein the first information indicates deactivation of the fixed beam for the SSB beam,
wherein the third information indicates activation of the fixed beam for the CSI-RS, and
wherein the CSI report further comprises information on an interference amount of the fixed beam with respect to the CSI-RS based on the activated fixed beam.

6. The method of claim 1, further comprising:
estimating a location of the UE, based on the second information; and
mapping the estimated location of the UE and multiple antenna panels,
wherein the third information comprises information in which the location of the UE and the multiple antenna panels are mapped.

7. The method of claim 2, further comprising:
configuring a fixed beam interference map indicating an interference level of a fixed beam for each antenna panel of the base station;
activating the fixed beam to transmit a first sounding reference signal (SRS) request to the UE via RRC signaling;
receiving a first SRS from the UE;
deactivating the fixed beam to transmit a second SRS request to the UE via RRC signaling;
receiving a second SRS from the UE; and
updating the fixed beam interference map, based on the first SRS and the second SRS.

8. The method of claim 7,
wherein the first SRS is used to estimate a first uplink channel,
wherein the second SRS is used to estimate a second uplink channel, and
wherein the fixed beam interference map is updated based on a difference between an estimated value of the first uplink channel and an estimated value of the second uplink channel.

9. The method of claim 7,
wherein the fixed beam interference map is configured based on information on the DMA and spatial information of the base station.

10. The method of claim 7,
wherein the fixed beam interference map is used to identify the transmission strategy for the fixed beam.

11. A base station in a wireless communication system, the base station comprising:
at least one transceiver;
at least one processor communicatively coupled to the at least one transceiver; and
at least one memory, communicatively coupled to the at least one processor, storing instructions executable by the at least one processor individually or in any combination to cause the base station to:
transmit, to a user equipment (UE), via radio resource control (RRC) signaling, first information indicating whether a fixed beam is activated,
transmit, to the UE, a synchronization signal block (SSB) beam, based on the first information,
receive, from the UE, second information including information on an intensity of the SSB beam,
transmit, to the UE, via the RRC signaling, third information indicating whether the fixed beam is activated,
transmit, to the UE, a channel state information reference signal (CSI-RS), based on the third information,
receive a CSI report from the UE,
identify a transmission strategy for the fixed beam, based on the second information and the CSI report, and
transmit, to the UE, data, based on the identification.

12. The base station of claim 11,
wherein the SSB beam and the CSI-RS are transmitted via a dynamic metasurface antenna (DMA), and
wherein the first information or the third information indicates whether a fixed beam based on information on the DMA is activated.

13. The base station of claim 11,
wherein the fixed beam indicates a beam having an uncontrollable direction on an antenna panel of the base station.

14. The base station of claim 11,
wherein the first information indicates activation of the fixed beam for the SSB beam,
wherein the third information indicates deactivation of the fixed beam for the CSI-RS,
wherein the second information further comprises information on an interference amount of the fixed beam with respect to the SSB beam based on the activated fixed beam, and
wherein the information on the intensity of the SSB beam indicates a received signal strength indicator (RSSI) and reference signal received power (RSRP) of the SSB beam.

15. The base station of claim 11,
wherein the first information indicates deactivation of the fixed beam for the SSB beam,
wherein the third information indicates activation of the fixed beam for the CSI-RS, and
wherein the CSI report further comprises information on an interference amount of the fixed beam with respect to the CSI-RS based on the activated fixed beam.

16. The base station of claim 11, wherein the controller is further configured to:
estimate a location of the UE, based on the second information; and
map the estimated location of the UE and multiple antenna panels, and
wherein the third information comprises information in which the location of the UE and the multiple antenna panels are mapped.

17. The base station of claim 12, wherein the controller is further configured to:
configure a fixed beam interference map indicating an interference level of a fixed beam for each antenna panel of the base station;
activate the fixed beam to transmit a first sounding reference signal (SRS) request to the UE via RRC signaling;
receive a first SRS from the UE;
deactivate the fixed beam to transmit a second SRS request to the UE via RRC signaling;
receive a second SRS from the UE; and
update the fixed beam interference map, based on the first SRS and the second SRS.

18. The base station of claim 17,
wherein the first SRS is used to estimate a first uplink channel,
wherein the second SRS is used to estimate a second uplink channel, and
wherein the fixed beam interference map is updated based on a difference between an estimated value of the first uplink channel and an estimated value of the second uplink channel.

19. The base station of claim 17,
wherein the fixed beam interference map is configured based on information on the DMA and spatial information of the base station.

20. The base station of claim 17,
wherein the fixed beam interference map is used to identify the transmission strategy for the fixed beam.
